(19) United States
(12) Patent Application Publication
(10) Pub. No.: US 2011/0010214 A1
(43) Pub. Date: Jan. 13, 2011

(54) Method and system for project management

(76) Inventor: J. Scott Carruth, Austin, TX (US)

Correspondence Address: EDELL, SHAPIRO, & FINNAN, LLC, 1901 RESEARCH BOULEVARD, SUITE 400, ROCKVILLE, MD, 20850, US

(21) Appl. No.: 11/824,210

(22) Filed: Jun. 29, 2007

(51) Int. Cl. G05B 19/418

(52) U.S. Cl. 705/8

(57) ABSTRACT

Methods and systems of project management can utilize work packages to produce a project result. Methods and systems of project management can comprise defining work packages for a project and arranging the defined work packages in a sequence of execution such that the execution of the sequenced work packages produces a project result in accordance with a goal of the project. A method of defining a work package can comprise analyzing project materials of a project to determine stand alone work, grouping one or more tasks implementing the stand alone work to form a stand alone set of one or more tasks, wherein the work package comprises the set of one or more tasks, wherein the set of one or more tasks defines the work package and wherein the performance of the set of one or more tasks during the execution of the work package produces a deliverable.

### TECHNICAL FIELD OF THE INVENTION

The present invention relates to methods and systems for project management. More particularly, the present invention relates to methods and systems for grouping sets of tasks in the context of a project. Even more particularly, the present invention relates to methods and systems for grouping tasks such that work packages comprising one or more tasks may be defined.

### BACKGROUND

Businesses and individuals use project management methodologies to organize and manage various projects. A project can have one or more goals and one or more project results (e.g. a product) may be produced in accordance with one or more of the goals of the project. The completion of work may be required to produce a project result in accordance with a goal. To realize the desired goal and produce the desired project result, a set of tasks may be defined for the project and various resources which may be used in conjunction with the project may be allocated to one or more of the tasks. The performance of one or more tasks may complete work required to produce a project result in accordance with the desired goal.

By performing these tasks utilizing the allocated resources, the desired goal may be accomplished and one or more project results may be produced in accordance with the desired goal. For example, in the context of a project with a goal of installing and configuring a computer system, a set of tasks can be defined for the project. The performance of these tasks may complete work required to install and configure a computer system. The set of tasks can include, for example, installing various software or hardware components. Resources such as personnel, hardware components and software programs, or any other type of resource may be allocated as appropriate to each task such that through the accomplishment of the tasks, utilizing these allocated resources, a computer system can be installed and configured.

### SUMMARY

A method and system for project management may comprise grouping tasks into sets of tasks to define one or more work packages. More particularly, embodiments of a method and system of project management may include defining (e.g. defining or developing) work packages such that each of the work packages comprises one or more tasks. More particularly, embodiments comprise analyzing project materials of a project to determine a set of one or more tasks which produce a particular result. The one or more tasks can be grouped together to define a work package where the result produced by the tasks comprising the work package may be a deliverable of the work package. To enable the performance of the tasks comprising the work package, the work package can be developed by allocating resources to or defining or developing processes for the work package.

Within the context of a project, defined work packages may be arranged in one or more sequences of execution such that the execution of the work packages produces a project result in accordance with a goal of the project. Work packages may utilize deliverables produced by other work packages, giving rise to dependencies between or among work packages or deliverables. In the context of a project, work packages may be arranged in one or more sequences of execution based on one or more dependencies between or among work packages or deliverables.

In one embodiment, work packages may be utilized in a project with a goal of installing and configuring a computer system such as a master entity index system. Managing such a project may comprise defining and developing work packages whose deliverables complete aspects or components of the project such that when the work packages of the project have been executed, a master entity index system has been installed and configured. Managing such a project may further comprise arranging work packages within the project into a sequence of execution such that the execution of the sequenced work packages results in the installation and configuration of a master entity index system.

The definition of work packages or the arrangement of work packages may allow for more effective project management. Work packages may be arranged in one or more sequences of execution as desired. A particular arrangement or sequence of work packages may have one or more advantages over other arrangements or sequences of work packages. For example, a particular arrangement of work packages may produce crucial deliverables as soon as possible or maximize the efficiency of deliverable production. Work packages may produce independently utilizable deliverables. Work packages may also be arranged according to the availability of resources. For example, a project manager may arrange one or more work packages such that one or more work packages are executed when resources utilized by the one or more work packages are readily available. Within a project, work packages may be arranged to balance workload within the project. For example, work packages may be arranged such that the bulk of the work packages are completed at the front of the project such that the bulk of the work associated with the project is completed at the front-end of the project.

### BRIEF DESCRIPTION OF THE FIGURES

A more complete understanding of embodiments and the advantages thereof may be acquired by referring to the following description, taken in conjunction with the accompanying drawings in which like reference numbers indicate like features and wherein:

FIG. 1 is a diagrammatic representation of one example of a project;

FIG. 2 is a diagrammatic representation of one embodiment of a project;

FIG. 3 is one embodiment of a methodology of defining a work package;

FIG. 4 is a diagrammatic representation of one embodiment of a work package;

FIG. 5 is one embodiment of a methodology for developing a work package;

FIG. 6 is one embodiment of a methodology for developing a work package;

FIG. 7 is one embodiment of a methodology of arranging work packages;

FIG. 8 is a diagrammatic representation of one embodiment of a system;

FIG. 9 is a block diagram of an example result produced in accordance with a goal of a project;

FIG. 10 is one embodiment of a methodology of defining or developing a work package;

FIG. 11 is a representation of one embodiment of a work package;

FIG. 12 is a representation of one embodiment of a work package;

FIG. 13 is a representation of one embodiment of a work package;

FIG. 14 is a representation of one embodiment of a work package; and

FIG. 15 is a diagrammatic representation of one embodiment of a portion of a project.

### DETAILED DESCRIPTION

Embodiments are illustrated in the FIGURES, like numerals being used to refer to like and corresponding parts of the various drawings.

In the context of a project, to complete work so as to produce a project result in accordance with a goal (i.e. a goal of the project stipulates one or more corresponding project results of the project) of the project, tasks of the project may be performed in an order such that the project result is produced. Using project management techniques, in the context of a project, tasks may be arranged in series such that a task is performed before a subsequent task is begun, such that upon the performance of all the tasks in series, a project result (e.g. a product) is produced in accordance with a goal of the project. Depending upon the task, the performance of the task may or may not result in a discernable result that can be quantified in the context of the project.

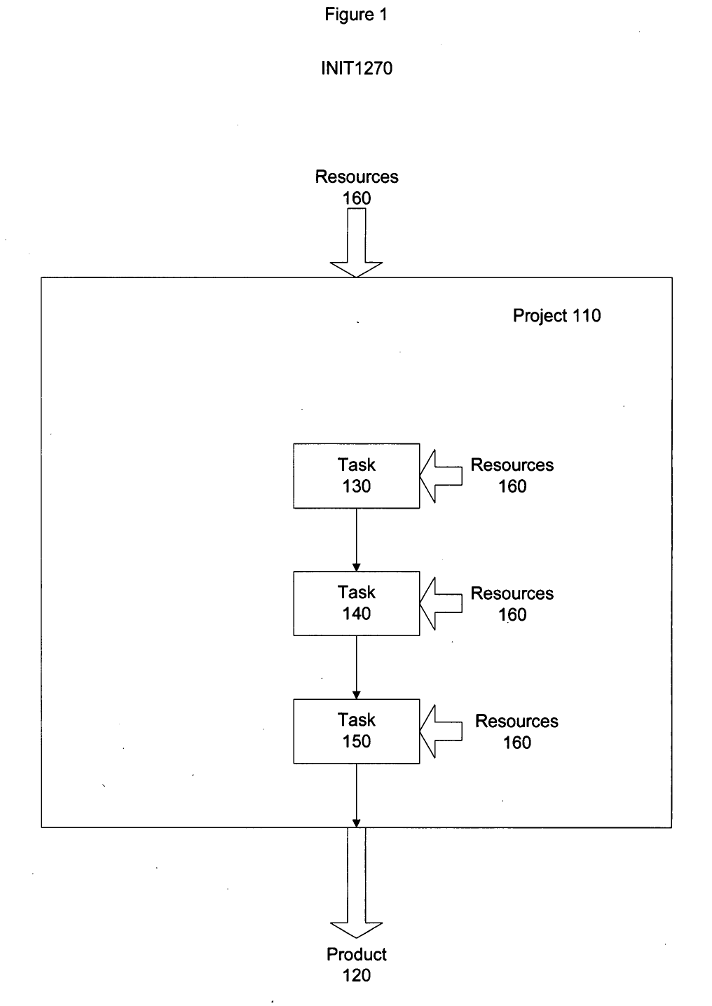

Turning to FIG. 1, FIG. 1 depicts an embodiment of a management methodology. FIG. 1 depicts one example of a project 110 which produces product 120 in accordance with a goal of project 110. Project 110 comprises task 130, task 140 and task 150. Tasks 130, 140 and 150 complete work of project 110 such that when tasks 130, 140 and 150 have been performed, project 110 is complete and product 120 has been produced. Resources 160 are allocated to project 110. Within project 110, resources 160 are allocated among tasks 130, 140 and 150. Resources 160 can include raw materials, tools, individuals charged with performing tasks, or any other type of resource. The performance of a task may or may not result in a tangible result. The performance of a task may or may not result in a stand alone result. In one project management methodology, tasks 130, 140 and 150 are performed in a serial order such that product 120 is produced at the end of project 110.

In project 110 of FIG. 1, because each task may not result in a tangible or stand alone result, it may not be possible to clearly discern if a project milestone has been met. Furthermore, it may not be possible to clearly demonstrate progress in the completion of the project before the project has been completed because at any one time during the performance of tasks, a tangible result may or may not exist. In addition, the serial completion of tasks, as shown in project 110 of FIG. 1, may be inefficient because one or more tasks may be capable of being completed independent of the completion of other tasks, allowing for tasks to be completed in a more efficient non-serial order. The serial completion of tasks may prolong the completion of a project because the one or more tasks which may be able to be completed simultaneously with other tasks may be completed in series with the other tasks, lengthening the time required to complete the project. Still further, the serial completion of tasks may be inefficient because it may be more cost effective to perform particular tasks non-serially, for example, when resources for particular tasks are most readily available or available at least cost.

To overcome inefficiencies common to the serial completion of tasks, tasks associated with a project may be grouped into work packages where these work packages can be utilized to complete the project. For example, work packages of a project may be executed such that tasks comprising the work packages are performed at the same time, thus completing the project. In one embodiment, work packages are independent and distinct from each other.

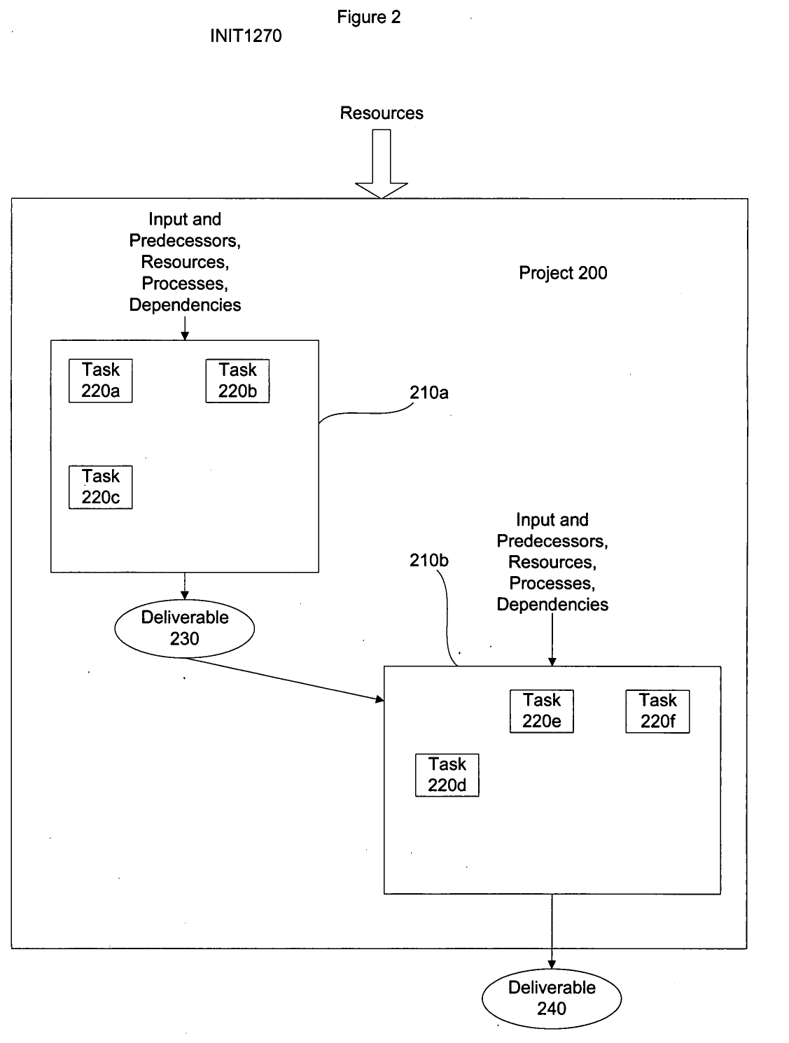

FIG. 2 is a diagrammatic representation of one embodiment of a project comprising work packages. In project 200 of FIG. 2, work packages 210a and 210b contain tasks 220a-220c and 220d-220f, respectively and are each associated with input and predecessors, resources, processes and dependencies. Utilizing the associated input and predecessors, resources, processes and dependencies, work packages 210a and 210b produce deliverables 230 and 240, respectively, where work package 210b utilizes deliverable 230 to produce deliverable 240, where deliverable 240 is a project result of project 200. Thus, work packages 210a and 210b can be utilized to complete project 200.

In the context of a project, work to be performed may be independent or distinct from other work, such work is stand alone work. A set of tasks can complete stand alone work. Depending on a task or tasks, a result of a task or tasks can be independent or distinct from the results of other tasks within the project, such a result is a stand alone result. A set of tasks can be independent or distinct form other tasks within a project, such a set of tasks is a stand alone set of tasks.

Tasks can be grouped into work packages such that each work package comprises a set of one or more tasks. The set of tasks within a work package may be a stand alone set of tasks which completes stand alone work. A work package may be defined by the set of one or more tasks it comprises. The performance of the set of tasks within each work package may produce a result that is a stand alone result; such a stand alone result may be referred to as a deliverable. Thus, each work package may comprise a stand alone set of tasks which produce a stand alone result referred to as a deliverable. For example, the execution of a work package may comprise the performance of the tasks comprising the work package such that a deliverable is produced. Because each work package comprises stand alone tasks and produces a deliverable, each work package may be independent and distinct from other work packages in a project. The independent and distinct nature of work packages allows work packages to be arranged in various sequences of execution to achieve various project management objectives.

The performance of a task in a set of tasks may produce a discernable result that can be quantified in the context of the project; the performance of such a task produces a tangible result. A work package can comprise a set of tasks which includes a task which produces a tangible result. The execution of such a work package may produce a tangible result. In one embodiment, a deliverable is a tangible result.

For example, in the context of a project with a goal of installing a computer system, the completion of a stand alone set of work may result in the installation and configuration of a host computer which is a part of the computer system. The performance of various tasks may complete the stand alone set of work, resulting in the installation and configuration of the host computer, a stand alone result. These various tasks may be grouped together to form a set of tasks (e.g. a stand alone set of tasks), which may, in turn, comprise a work package.

Embodiments of methods or systems for project management may include defining work packages which produce one or more deliverables, in turn, these work packages may be grouped into a project. A project can comprise a plurality of work packages. Work packages can be arranged in one or more sequences of execution within a project and deliverables produced by one or more work packages can be utilized to produce a project result (e.g. a product) in accordance with a goal of the project. Work packages may utilize one or more deliverables to produce deliverables. A deliverable can be a project result in accordance with a goal of a project.

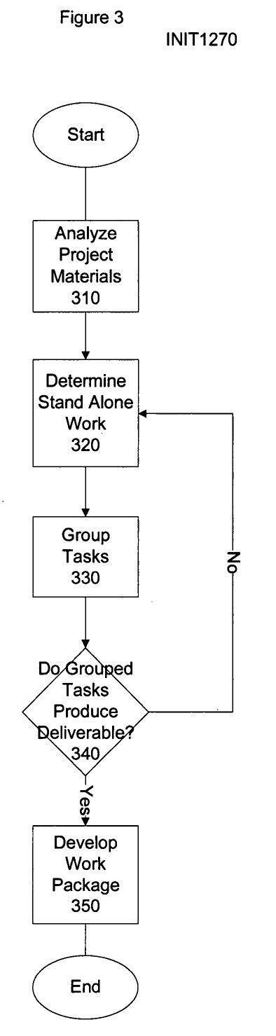

FIG. 3 is one embodiment of a methodology of defining (e.g. defining or developing) a work package. At analyze project materials step 310, project materials associated with a particular project are analyzed. Project materials can include a goal or tasks associated with a project, the completion of which may result in the realization of the project (i.e. one or more project results are produced in accordance with a goal of the project). At analyze project step 310, work to be performed to produce a project result in accordance with a goal of the project may also be analyzed. At determine stand alone work step 320, work which can stand alone or be completed by a set of tasks to produce a stand alone result is determined. At group tasks step 330, tasks associated with work determined at step 320 are grouped together to form a stand alone set of tasks which produce a stand alone result. The completion of the set of tasks associated with stand alone work may complete the work. To find a set of tasks which completes the desired work, tasks and groups of tasks may be analyzed to determine a stand alone set of tasks which complete the desired work. For example, a particular set of tasks may complete the desired work, while other sets of tasks may complete more than or less than the desired work. The tasks grouped together to form the set of tasks may be tasks such that the set of tasks to implement the desired work may be the minimum set of tasks which can be performed to complete the desired work. At step 340, the set of tasks formed at step 330 is analyzed to determine if the set of tasks stands alone or produces a deliverable. If the set of tasks stands alone or produces a deliverable, then a work package has been defined and at develop work package step 350, the defined work package can be developed. If, at step 340, the set of tasks are determined not to produce a deliverable, steps 320 and 330 are repeated as an iterative process until, at step 340, it has been determined that a set of tasks result in a deliverable.

At develop work package step 350 of FIG. 3, the work package defined through steps 310, 320, 330 and 340 is developed. Developing a work package may include allocating the appropriate resources to a work package. Developing a work package may also include adding processes to the work package or may include developing processes for the work package. Processes may be utilized to complete one or more tasks of the work package. Dependencies between and among work packages or deliverables may also be included as part of the work package. For example, a work package may utilize the deliverable of another work package to produce one or more deliverables. This relationship or similar relationships with other work packages or deliverables may be included in or as part of the definition of the work package at develop work package step 350. Input and predecessors may also be included in the definition of the work package at develop work package step 350. Input and predecessors may include government regulations or input from regulatory bodies, or any other form of input and predecessors utilized to develop the work package and allow the work package to be executed as a stand alone entity.

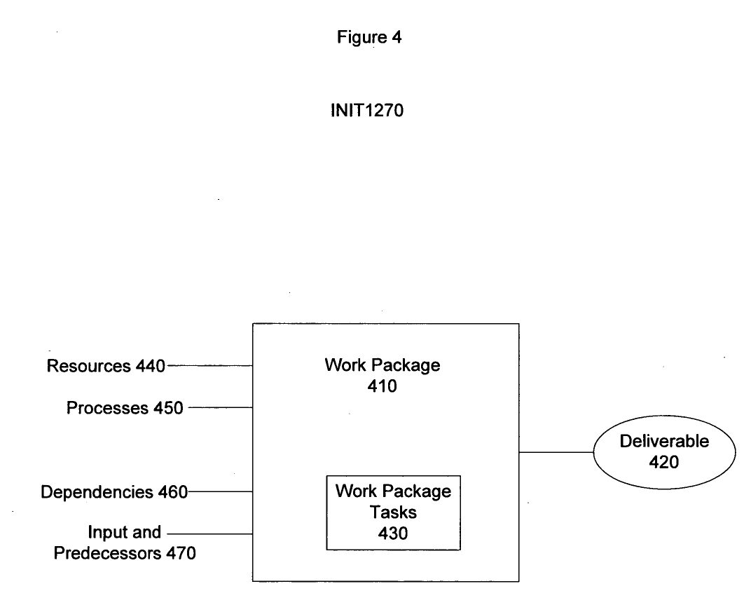

FIG. 4 is one example of a diagrammatic representation of one embodiment of a work package. Work package 410 may be a stand alone entity which can be executed separately from other work packages. In other words, a work package can comprise a stand alone set of tasks which produce a deliverable. A deliverable can be a stand alone result. Work packages may be repeatable and may be used in the context of more than one project. The execution of work package 410 of FIG. 4 results in the production of deliverable 420. Work package 410 includes work package tasks 430. In the context of a project, work package tasks 430 may be a subset of the tasks required to produce a project result in accordance with a goal. The performance of work project tasks 430 may result in the production of one or more deliverables which may include deliverable 420. Work package 410 may be allocated resources 440, which may include materials, time, personnel, deliverables or any other form of resource. Resources 440 can be utilized in conjunction with the performance of work package tasks 430 to produce deliverable 420. Work package 410 may include processes 450. Processes 450 may include work processes, product development processes or any other type of process. Processes 450 may be used in conjunction with work package tasks 430 or resources 440 to produce deliverable 420. Processes 450 may include processes for the performance of one or more tasks of work package tasks 430.

Work package 410 of FIG. 4 can include or be associated with dependencies 460. Dependencies 460 can include dependencies between or among work package 410 and other work packages or deliverables which may be produced by other work packages. Dependencies between or among work packages or deliverables can include associations between or among work packages or deliverables. Dependencies 460 can include dependencies to work packages which utilize deliverable 420 or deliverables produced utilizing deliverable 420, or can include dependencies to deliverables or work packages which produce deliverables which are utilized to produce deliverable 420. Dependencies 460 can also include dependencies to work packages or deliverables which are associated with the production of one or more deliverables which may be utilized by work package 410.

Work package 410 of FIG. 4 may further be associated with or include input and predecessors 470. Input and predecessors 470 may include quality control mechanisms or rules, safety regulations, estimations of effort, benchmarks regarding the results of tasks or any other component or element that may be part of or complete a work package. For example, safety regulations and measurements regarding safety regulations may be included as input to a work package.

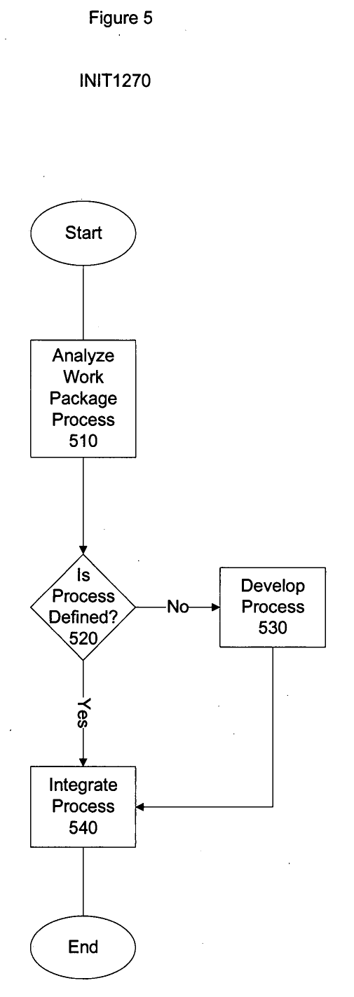

FIG. 5 is an example of one methodology for developing or integrating a process, e.g. process 450 of FIG. 4, in the context of a work package. One or more processes may be associated with a work package. For example, a process can be a process related to the performance of one or more tasks of the work package or can be any process relating to the execution of the work package. At analyze work package process step 510, a process associated with the work package is analyzed. Based on the analysis performed at step 510, at step 520 it is determined if the process is defined. If the process is not defined or the definition of the process or steps of the process is not adequate, at develop process step 530, the process is developed until the process is defined. At integrate process step 540, the defined process is integrated into the associated work package. Processes or parts of processes can be leveraged to be used in one or more work packages. For example, a process may be defined for the installation of particular software on a particular type of hardware device. Once this process has been defined, it may be integrated into multiple work packages.

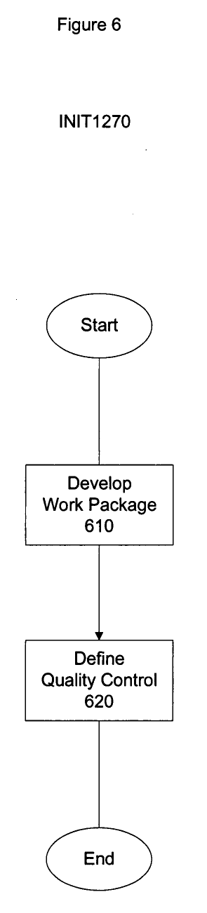

FIG. 6 is an example of one methodology for instituting quality control in the context of a work package. At develop work package step 610 of FIG. 6, a work package is developed. At define quality control step 620, quality control for a work package is defined. Quality control can, for example, govern one or more processes of a work package, govern one or more deliverables produced by a work package, or govern the results of one or more tasks of a work package. In one embodiment, quality control can be associated with or integrated into a work package. In embodiments, quality control or elements of quality control can be leveraged to be associated with one or more work packages. For example, if an element of quality control for a work package governs a process of the work package, the element of quality control may be leveraged to govern the same process integrated into other work packages.

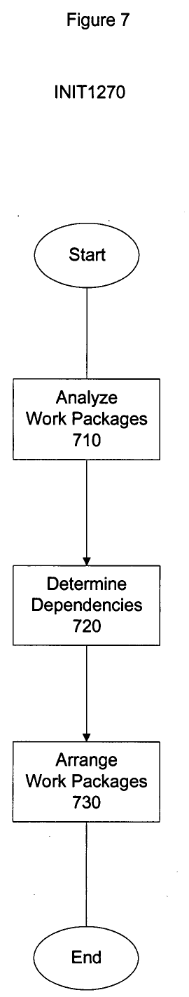

In the context of a project, one or more arrangements of work packages may produce a project result in accordance with one or more goals of a project. Different sequences of execution of work packages may have different advantages such that a particular arrangement of work packages may best comport with one or more project management objectives such as reducing cost or meeting project deadlines. FIG. 7 is an example of a methodology of arranging work packages within a project. At analyze work packages step 710 of FIG. 7, work packages are analyzed in the context of a project, available resources and deliverables or products to be produced. For example, specialized resources may only be available to a project for a limited time. One or more work packages may need to utilize the specialized resources. Such conditions may be considered at analyze work packages step 710.

Based upon the analysis of the work packages performed at analyze work packages step 710, at determine dependencies step 720 of FIG. 7, dependencies among or between work packages are determined. Determining dependencies may comprise determining if a work packages utilizes one or more deliverables. If a work packages utilizes one or more deliverables, it may be determined which work packages produce those deliverables. For example, a second work package may utilize a deliverable produced by a first work package. Thus, there may be a dependency between the first and second work packages. Similarly, determining dependencies may comprise determining if a deliverable produced by a work package is utilized by one or more work packages and may further comprise determining which work packages utilize the deliverable. Determining dependencies may further comprise determining multiple dependencies among multiple work packages. For example, a plurality of work packages may be serially dependant such that a chain of dependencies exist. Chains of dependencies can merge into other chains of dependencies. Determine dependencies step 720 may comprise determining chains of dependencies.

Based upon the analysis of work packages performed at analyze work packages step 710 or the determination of dependencies performed at determine dependencies step 720, at arrange work packages step 730 of FIG. 7, work packages are arranged in a sequence. Dependencies between or among work packages may affect the sequence of execution of work packages. Despite the affects dependencies between or among work packages may have on the arrangement or sequence of work packages, there may be one or more possible arrangements or sequences of work packages. Work packages may be arranged in a sequence of execution such that deliverables utilized by one or more work packages are produced before the work packages utilizing the deliverables are executed. Producing deliverables before the deliverables are utilized may allow for efficient project progression. Other considerations may affect the arrangement or sequencing of work packages within a project. Analyzing such conditions may be part of analyze work packages step 710. For example, in some situations, it may be expedient to execute a work package at a certain time. This may affect the arrangement or sequencing of work packages performed at arrange work packages step 730. For example, in the context of a project, a particular deliverable may be required for meeting a funding deadline and so work packages may be arranged or sequenced to produce the required deliverable as soon as possible. In the context of a project, the stand alone nature of work packages and deliverables can allow for the arrangement and sequencing of work packages to be varied in accordance with various project management objectives as would be understood by one of ordinary skill in the art. By way of example, the arrangement and sequencing of work packages can be done so as to maximize resource consumption efficacies, swiftly meet project milestones, balance project workload, etc.

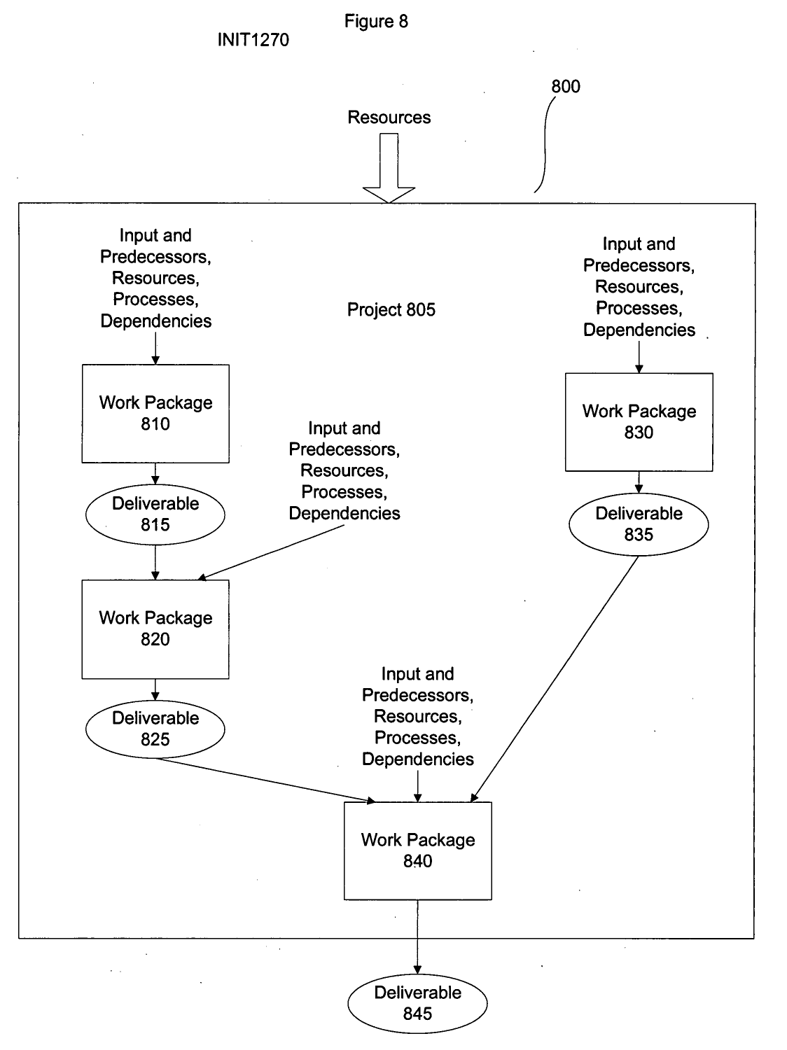

FIG. 8 is a diagrammatic representation of an embodiment of a project. In system 800 of FIG. 8, work packages 810, 820, 830 and 840 are arranged in a sequence of execution in the context of project 805. Work packages 810, 820, 830 and 840 produce deliverables 815, 825, 835 and 845, respectively. Deliverable 845 is a product of project 805 and may be a project result in accordance with a goal of project 805. Each work package is associated with input and predecessors, resources, processes and dependencies. A set of input and predecessors, resources, processes and dependencies associated with a work package can be utilized by that work package to produce a deliverable. One or more deliverables can be part of a set of input and predecessors, resources, processes and dependencies utilized by a work package to produce a deliverable. For example, in project 805, deliverable 815 may be utilized by work package 820 to produce deliverable 825.

The arrangement of work packages may be based upon dependencies. For example, in FIG. 8, work package 810 is arranged such that it is executed prior to work package 820. The execution of work package 810 results in deliverable 815 which is utilized by work package 820 to produce deliverable 825. Thus, there may be a dependency between work package 810 and work package 820 or between deliverable 815 and work package 820. Because work package 820 utilizes deliverable 815 to produce deliverable 825, work package 810 (which produces deliverable 815) may be executed prior to the execution of work package 820. Thus, the arrangement of work packages 810 or 820 may be based upon the dependency between work package 820 and work package 810 or deliverable 815. Likewise, because work package 840 utilizes deliverables 825 and 835, work packages 820 and 830 are arranged such that they are executed prior to work package 840. One possible arrangement of work packages is shown in FIG. 8. While the work packages of system 800 are arranged in a particular sequence of execution, in one embodiment of system 800, the time at which a work package is executed can be varied. For example, work package 810 may be executed any time before work package 820. Likewise, work package 830 may be executed any time before work package 840.

While in project 805 of FIG. 8, work packages may be arranged in a particular sequence of execution based on dependencies between or among work packages or deliverables, in other projects, dependencies between or among work packages or deliverables may allow for one or more arrangements or sequences of work packages. This flexibility may allow a project manager to arrange work packages according to one or more project management objectives, e.g. to maximize efficiencies, minimize costs or meet project or funding deadlines. For example, the price or availability of resources used by a work package may vary. The project manager may arrange work packages such that one or more work packages are executed when the resources utilized by work packages are at the lowest price or highest availability.

Embodiments of work packages may be used in a project with a goal of installing and configuring a computer system such as a master entity index system. One example of a master entity index system which may be implemented using embodiments of work packages is described in U.S. Pat. No. 5,991,758, entitled “SYSTEM AND METHOD FOR INDEXING INFORMATION ABOUT ENTITIES FROM DIFFERENT INFORMATION SOURCES”, which is hereby fully incorporated by reference.

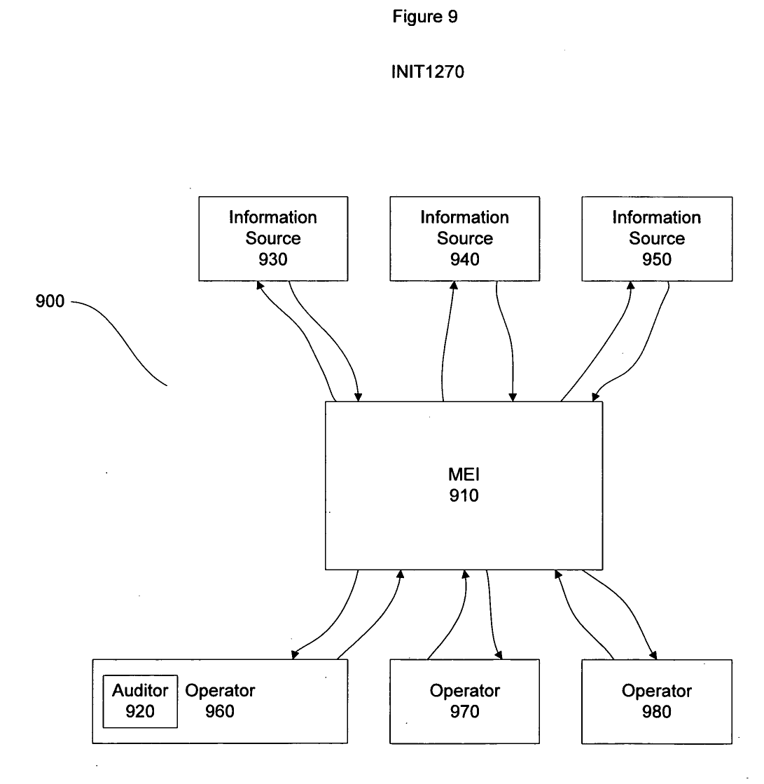

FIG. 9 is a block diagram of one embodiment of a master entity index system 900. Master entity index system 900 may include a master entity index (MEI) 910. MEI 910 may process, update or store data records about one or more entities from one or more information sources (e.g. information source 930, information source 940 or information source 950). MEI may respond to commands or queries from one or more operators (e.g. operator 960, operator 970 or operator 980).

MEI 910 may interface with an auditor 920 which may be part of operator 960. In the context of a project with a goal of installing and configuring master entity index system 900, the installation and configuration of auditor 920 may be a deliverable of a work package. Embodiments may be used to define and develop such a work package. Such a work package, which can be referred to as an auditor work package, can be executed to produce a deliverable, namely the installation and configuration of auditor 920 such that auditor 920 interfaces with MEI 910.

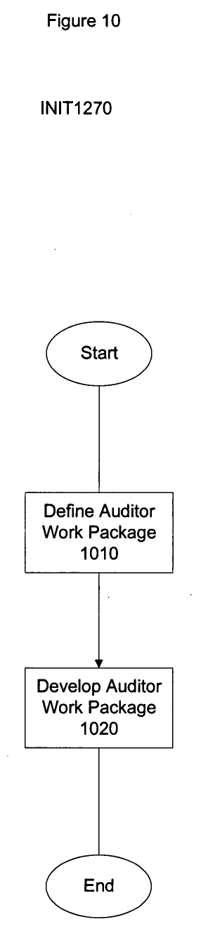

FIG. 10 is a flow diagram of one embodiment of a methodology for the definition (e.g. definition or development) of an auditor work package which can produce a deliverable which can be the installation and configuration of an auditor in the context of a master entity index system. At define auditor work package step 1010 of FIG. 10, an auditor work package which results in the installation and configuration of an auditor is defined. In one embodiment, defining a work package producing a deliverable which is the installation and configuration of an auditor comprises analyzing project materials. Analyzing project materials might comprise analyzing tasks to be performed within the context of a project with a goal of installing and configuring a master entity index system. In particular, analyzing tasks to be performed as part of the project may include analyzing tasks associated with the installation and configuration of an auditor. Such tasks might include installing or configuring an auditor in the context of a master entity index system.

In embodiments, define auditor work package step 1010 may further comprise determining stand alone work relating to the installation and configuration of an auditor. For example, in one embodiment, determining stand alone work can include determining a set of work that results in the installation and configuration of an auditor. In embodiments, define auditor work package step 1010 may further comprise grouping tasks associated with the completion of the stand alone work such that a set of tasks is developed, the completion of which results in the installation and configuration of an auditor. For example, the set of tasks might include a task such as running ah auditor installation software program on a computer hosting an operator, e.g. operator 960 of FIG. 9. Another task in the set of tasks might be to configure the MEI such that the MEI interacts with the auditor. In embodiments, define auditor work package step 1010 is completed when a deliverable, e.g. the installation and configuration of an auditor, and a set of tasks which can produce the deliverable have been defined. Thus, an auditor work package may be defined when a set of tasks resulting in the installation and configuration of an auditor has been formed.

At develop auditor work package step 1020 of FIG. 10, subsequent to define auditor work package step 1010, the auditor work package defined at step 1010 is developed. Develop auditor work package step 1020 may include allocating the appropriate resources to the auditor work package. Develop auditor work package step 1020 may also include associating the appropriate processes with the work package or may include developing processes for the work package. Processes associated with the auditor work package may be included in or integrated into the work package. Embodiments of processes to be included in the auditor work package may include processes for installing or configuring the auditor or configuring an MEI to interact with the auditor.

In embodiments, at step 1020, dependencies between and among the auditor work package and other work packages may also be included as part of the auditor work package. For example, the auditor work package may utilize one or more deliverables produced by other work packages. Thus, in embodiments, the auditor work package may not be able to be executed until one or more deliverables have been produced through the execution of other work packages. Such deliverables might include: installation of the MEI and preparation of data. In embodiments, these dependencies may be included in the auditor work package at develop auditor work package step 1020. Input and predecessors may also be integrated into the auditor work package at develop auditor work package step 1020. In embodiments, input and predecessors can include the estimated level of effort to execute the work package or perform tasks or processes of the work package. Similarly, input and predecessors can include the estimated amount of time required to perform tasks or execute the work package.

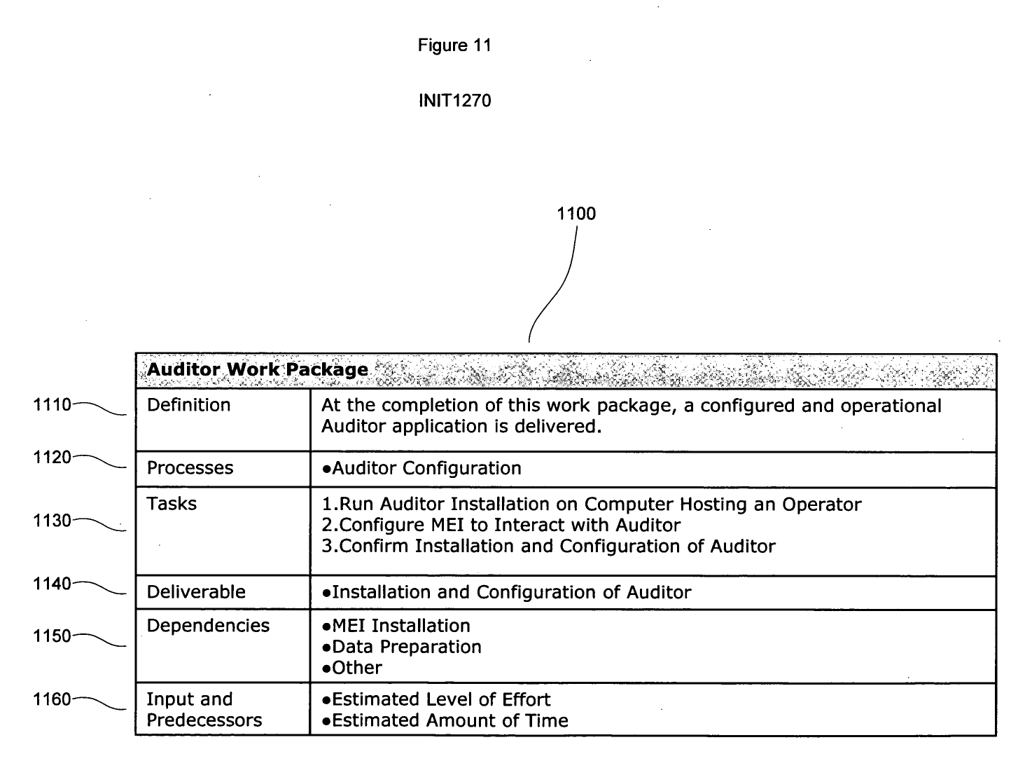

FIG. 11 is one example of a representation of one embodiment of an auditor work package. Auditor work package representation 1100 includes definition 1110 which describes the deliverable produced by the auditor work package represented by representation 1100. Auditor work package representation 1100 includes processes 1120, tasks 1130, deliverable 1140, dependencies 1150 and input and predecessors 1160. Processes 1120 lists processes associated with or utilized by the represented auditor work package. Tasks 1130 lists tasks which may be performed as part of the execution of the represented work package. Deliverable 1140 lists a deliverable produced by the represented auditor work package. Dependencies 1150 lists dependencies associated with the represented auditor work package. Input and predecessors 1160 lists one or more inputs or predecessors associated with the represented auditor work package.

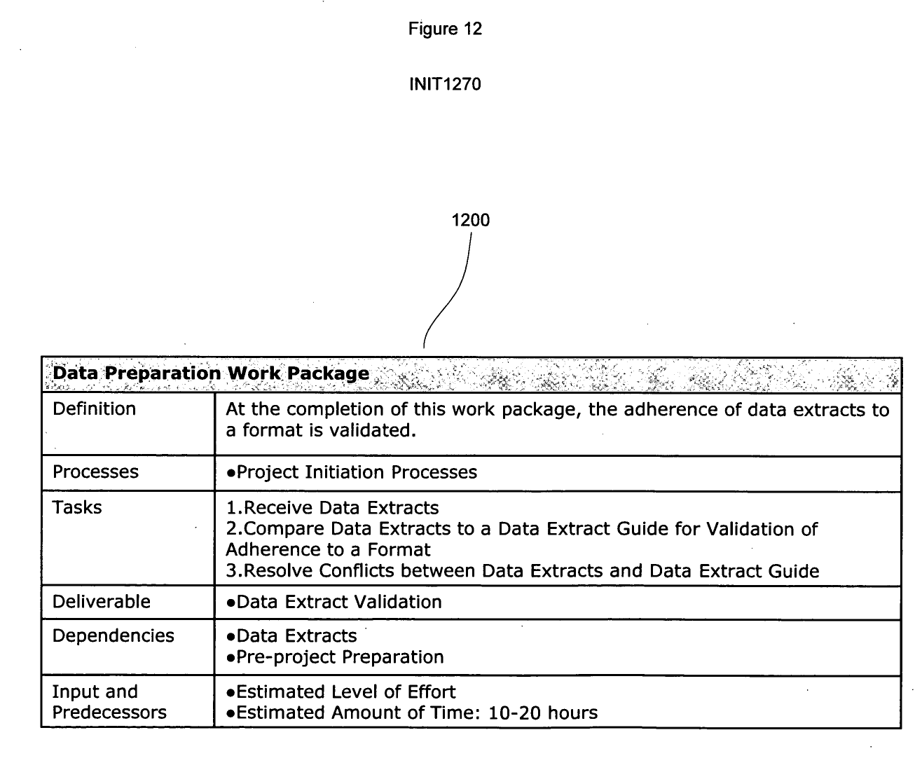

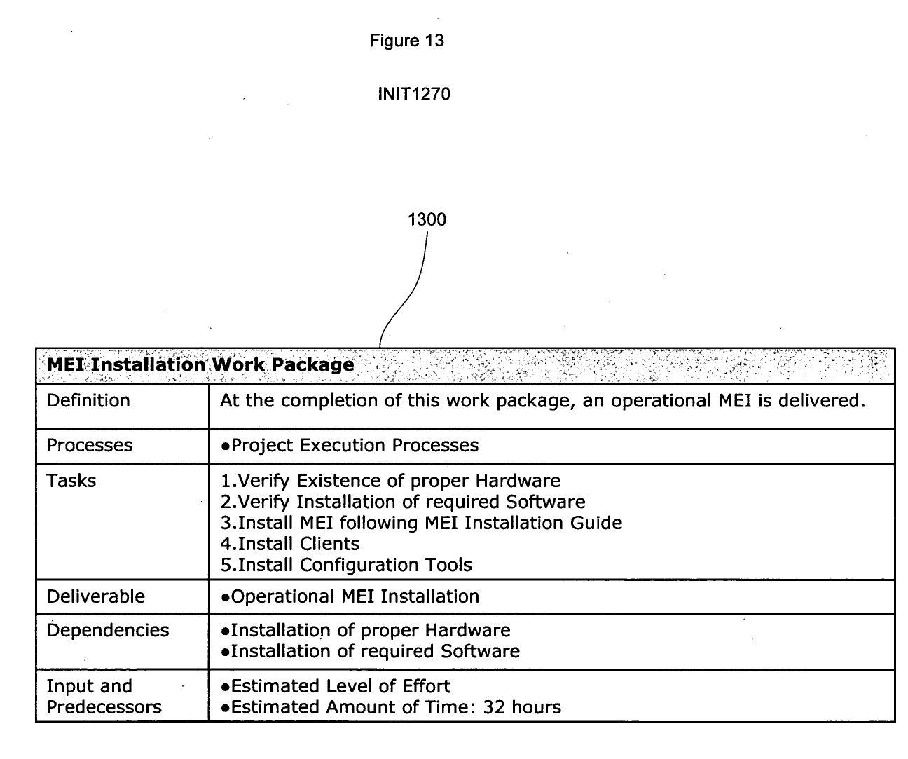

FIGS. 12 and 13 are examples of representations of embodiments of work packages to which an auditor work package may have dependencies. Data preparation work package representation 1200 of FIG. 12 represents an embodiment of a data preparation work package. An auditor work package may utilize one or more deliverables produced by the data preparation work package. MEI installation work package representation 1300 of FIG. 13 represents an embodiment of a MEI installation work package. The MEI installation work package produces a deliverable which is the installation of an operable MEI. An auditor may be configured to interact with the MEI. Before an auditor can be configured to interact with a MEI, the MEI may have to be installed. Thus there may be a dependency between an auditor work package and the MEI installation work package or the deliverable of the MEI installation work package, i.e. an operable MEI.

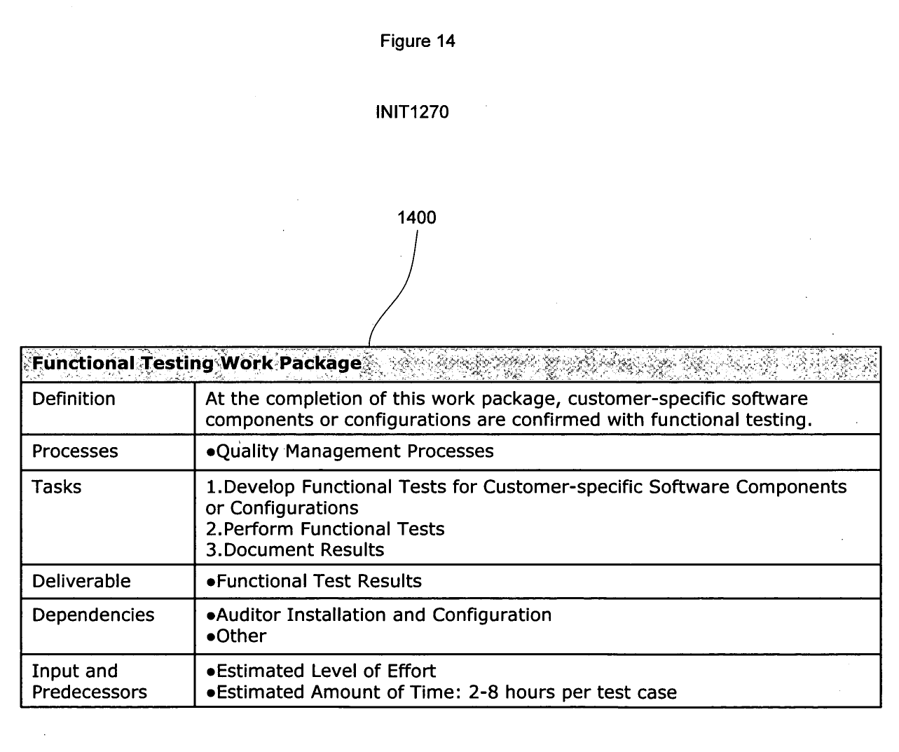

FIG. 14 is an example of a representation of a work package which may have dependencies to an auditor work package. Functional testing work package representation 1400 of FIG. 14 represents an embodiment of a functional testing work package. A functional testing work package may test the functionality of an auditor. Thus, there may be a dependency between the functional testing work package and an auditor work package or an auditor; for example, it may be necessary to install and configure an auditor before the functional testing work package can be executed to test the auditor.

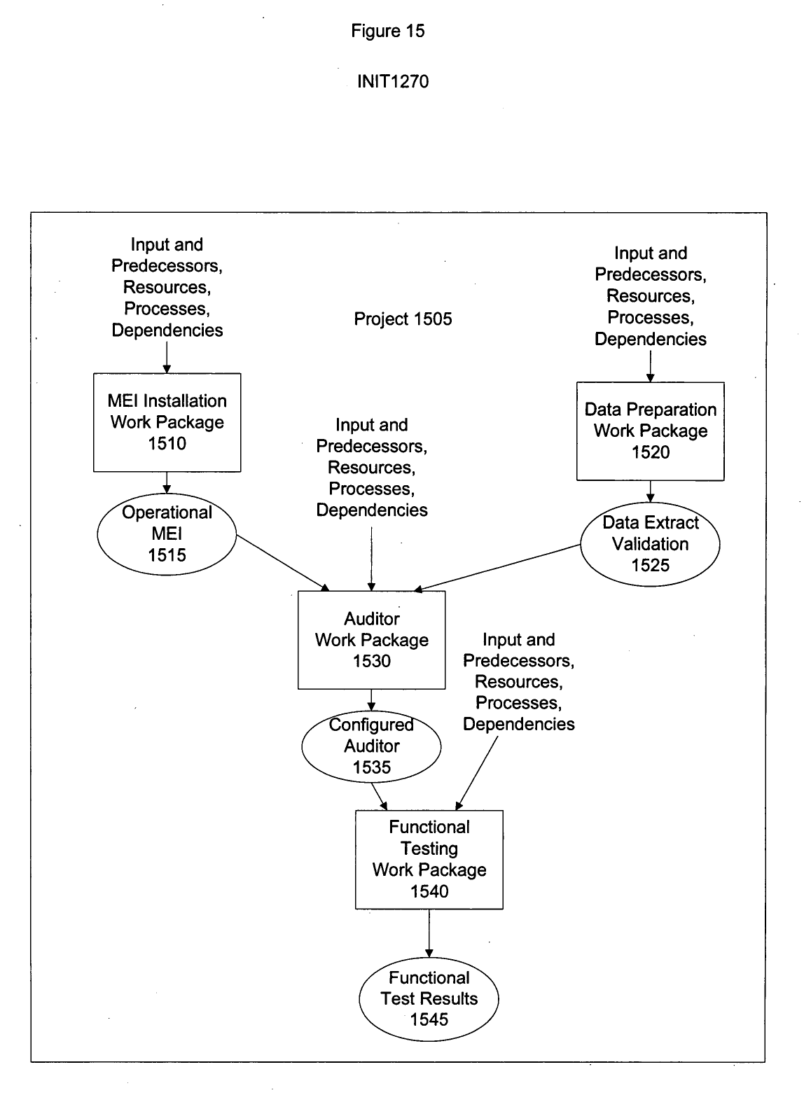

FIG. 15 is a diagrammatic representation of an embodiment of a portion of a project 1505. A goal of project 1505 is the installation and configuration of a master entity index system. Project 1505 comprises work packages which include MEI installation work package 1510, data preparation work package 1520, auditor work package 1530 and functional testing work package 1540. Based on dependencies between or among work packages of project 1505, work packages 1510, 1520, 1530 and 1540 are arranged in a sequence of execution. Auditor work package 1530 has dependencies to MEI installation work package 1510 and data preparation work package 1520. More specifically, auditor work package 1530 utilizes deliverables operational MEI 1515 and data extract validation 1525, produced by MEI installation work package 1510 and data preparation work package 1520, respectively. Because auditor work package 1530 has dependencies to MEI installation work package 1510 and data preparation work package 1520, within the context of project 1505, work packages are arranged in a sequence of execution such that the execution of MEi installation work package 1510 and data preparation work package 1520 precede the execution of auditor work package 1530. Likewise, because functional testing work package 1540 utilizes a deliverable produced by auditor work package 1530—i.e. configured auditor 1535—to produce functional test results 1545, auditor work package 1530 and functional testing work package 1540 are arranged in sequence based on dependencies between the work packages such that the execution of auditor work package 1530 precedes the execution of functional testing work package 1540.

Other work packages may be defined and developed for a project with a goal of installing and configuring a master entity index system. Representations of embodiments of work packages which may be utilized in the context of a project to install and configure a master entity index system are reproduced in Appendix A.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed in the following claims.

APPENDIX A
Pre-project Preparation

| | |
|---|---|
| Definition | Pre-project preparation includes all of the activities required to effectively understand |
| | the objectives of a specific engagement, key requirements of the specific customer, |
| | commitments made by Initiate to the customer, and any additional information |
| | necessary to take ownership of the engagement from the Sales organization. |
| Key Process | PM Project Initiation Processes |
| Tasks | 1. Review all formal documentation created for customer, including, all contracts, |
| | statement of work, proposals, entries in SalesForce.com, QuickArrow, et cetera. |
| | 2. Conduct a call with the respective Account Executive and Sales Consultant to |
| | review the high-level components involved, commitments made to the customer, |
| | customer objectives and requirements, et cetera. Identify initial customer point |
| | of contact. - Use Sales/Sales Consulting Transition Checklist |
| | 3. Perform introductory call with customer point of contact. Review high-level |
| | objectives, major milestones, key drivers/dates/dependencies for customer, et |
| | cetera. Agree on project kick-off date and obtain contact name for the data |
| | extract. - Use Pre-Project Preparation Call Checklist |
| | 4. Conduct initial data extract discussion with customer. Review attributes to be |
| | stored, format, constraints, et cetera. Use Data Extract Guide as a template, as |
| | the goal of this discussion is to obtain the content for the Data Extract Guide |
| | draft. Confirm date of data extract delivery. |
| | 5. Construct and execute Pre-Project Checklist |
| | Create shared project directory on Ludwig as a central repository of |
| | information for the project team. |
| | Create a secure FTP site for customer data management. (if necessary) |
| | Create project structure in QuickArrow for project resource, tracking and |
| | invoice management. |
| | Perform SDD (if necessary) to facilitate license invoice event. |
| | Obtain Initiate resources for the project from Project Directors. |
| | Conduct information exchange with Initiate resources. |
| | Create draft Project Plan from description of services in orders and |
| | understanding of customer from Sales. |
| | Create draft Revenue Forecast from description of services in orders and |
| | understanding of customer from Sales. |
| | 6. Distribute draft Data Extract Guide and communicate expected delivery date for |
| | the data extract. Obtain approval from customer. |
| Deliverable | Sales/Sales Consulting Transition Checklist |
| | Pre-project Preparation Call Checklist |
| | Data Extract Guide |
| | Updated Implementation Approach |
| Work Package | NA |
| Dependencies | |
| Customer | Customer point of contact |
| Dependencies | Customer data extract contact |
| Quality Control | Completed Sales/Sales Consulting Transition Checklist |
| | Completed Pre-project Preparation Call Checklist |
| | Approved Data Extract Guide |
| Participants | Initiate Account Executive |
| | Initiate Sales Consultant |
| | Initiate Project Manager |
| | Initiate Project Architect |
| | Customer Project Manager |
| | Customer Data Extract Contact |
| Initiate Effort | 8-16 hours |
| Required | |
| Customer | 3-5 hours |
| Effort Required | |

Data Preparation (Requirements)

| | |
|---|---|
| Definition | Data preparation includes all of the tasks necessary to validate the initial data |
| | extracts adhere to the expected format and can be consumed by the Initiate |
| | software. Minor data cleansing may also be included. |
| Key Process | PM Project Initiation Processes |
| Tasks | 1. Receive data extracts from customer. |
| | 2. Compare extract to the Data Extract Guide to ensure record counts, format, et |
| | cetera. - Use Data Validation Checklist |
| | 3. If there are any discrepancies between the Data Extract Guide and the data |
| | extract, determine whether Initiate will cleanse these changes or the customer |
| | should generate new extracts. |
| | 4. Communicate any discrepancies between the Data Extract Guide and the data |
| | extract and action plan to resolve these changes. |
| | 5. If Initiate will clean the file, ensure customer understands their extract process |
| | should be modified, or if the issue is from a source system, ensure they |
| | understand the exact steps used to cleanse the data as their update process, or |
| | the inbound broker, will need to accommodate these items. |
| | 6. Receive new extracts OR perform clean-up steps. |
| Deliverable | Data Validation Checklist |
| | Updated Implementation Approach |
| Work Package | Pre-Project Preparation |
| Dependencies | |
| Customer | Customer data extract contact |
| Dependencies | |
| Quality Control | Completed Data Validation Checklist |
| Participants | Initiate Project Manager |
| | Initiate Technical Analyst |
| | Customer Project Manager |
| | Customer Data Extract Contact |
| Initiate Effort | 8-16 hours |
| Required | |
| Customer | 2-4 hours. |
| Effort Required | Varies by customer - the complexity for each customer to extract from their source |
| | systems can range from simple to a very complex programming exercise. Also we |
| | could require additional extracts from the customer. |

Project Kickoff

| | |
|---|---|
| Definition | Project Initiation involves activities that facilitate the formal ‘start’ of any Services |
| | project. This work package includes both activities that are internal to Initiate and |
| | external to the customer. Clear descriptions of the project objectives, scope, |
| | deliverables, project duration and resource requirements are developed (confirmed) |
| | during project initiation. |
| Key Process | Project Initiation |
| | Project Planning and Management |
| | Communication Management |
| | Revenue Management |
| | Scope and Change Management |
| | Risk and Issue Management |
| Tasks | 1. Prepare for Project Kick-off meeting |
| | 2. Conduct Project Kick-off meeting |
| | 3. Create draft Implementation Approach from intelligence gathered at the Project |
| | Kick-off meeting. |
| | 4. Conduct deployment strategy session that includes client and implementation |
| | team |
| Deliverable | 1. working document, data, and project repositories created (Ludwig, QuickArrow, |
| | FTP site) |
| | 2. SDD delivered and completion signature obtained. |
| | 3. Assigned project team has an initial understanding of project. |
| | 4. Initial Revenue forecast delivered to Project Director. |
| | 5. Project kickoff meeting scheduled and conducted with Customer resulting in |
| | working drafts of Implementation Approach and Project Plan completion, |
| | archived and delivered to customer for feedback. |
| | 6. Updated Implementation Approach |
| | 7. Update project plan to reflect deployment strategy |
| Work Package | Pre-Project Preparation |
| Dependencies | Data Preparation |
| Customer | 1. Services Agreement signed (Sales activity) |
| Dependencies | 2. Customer has assigned project resources for the project |
| | 3. Customer project resources participate in Kick Off meeting. |
| Quality Control | Project Director reviews |
| Participants | Customer Account Executive |
| | Initiate Project Director |
| | Initiate Project Architect |
| | Initiate Project Manager |
| | Initiate Technical Analysts |
| | Customer Project Team |
| Initiate Effort | 36 hours |
| Required | |
| Customer Effort | 20 hours |
| Required | |

Process Appraisal

| | |
|---|---|
| Definition | This work package describes the activities associated with performing business |
| | process analysis of the customers existing data stewardship processes and |
| | procedures. |
| Key Process | Process Analysis Processes |
| Tasks | 1. Define the project objectives |
| | 2. Document “as-is” processes (diagnose) |
| | 3. Propose Redesign business processes and technology |
| | 4. Develop a cost/benefit analysis (if required) |
| | 5. Plan and Implement new “to be” processes and systems |
| | 6. Evaluate process performance |
| Deliverable | Process Analysis Report |
| Work Package | Data Preparation |
| Dependencies | Data Extract Load and Analysis |
| Customer | Available for interviews |
| Dependencies | Access to existing process documentation |
| Quality Control | Process Analysis and Recommendations reviewed by Initiate Architecture and |
| | Domain Experts resources |
| Participants | Initiate Project Manager |
| | Initiate Business Analysts |
| | Customer Project Manager |
| | Customer Process Experts |
| Initiate Effort | 15 Days |
| Required | |
| Customer Effort | 10 Days |
| Required | |

Solution Architecture

| | |
|---|---|
| Definition | This work package describes the activities associated with designing and refining the |
| | customer's Solution Architecture. |
| Key Process | Architecture Design Process |
| | Requirements Elicitation |
| Tasks | 1. Leverage the Solution Architecture target document as received from Sales |
| | Consulting as a starting point for determining the customers implementation |
| | architecture |
| | 2. Gather data and transactional volumes to prepare a hardware recommendation |
| | 3. Work with architects to prepare a hardware recommendation |
| | 4. Send the hardware recommendation to the customer |
| | 5. Communicate third-party software requirements to be installed by the customer |
| | on the hardware before Identity Hub ™ software installation |
| | 6. Review the implementation approach and customer technical and environmental |
| | requirements |
| | 7. Design the customer's Solution Architecture using the SA Visio templates and SA |
| | hardware sizing spreadsheet |
| | 8. Document Solution Architecture |
| | 9. Review with Architecture Team |
| | 10. Review with Project Team and Customer System Administrator |
| | 11. Integrate with Implementation Approach Document |
| Deliverable | Approved Solution Architecture |
| | Approved Technical Architecture |
| | Updated Implementation Approach |
| Work Package | Data Preparation |
| Dependencies | |
| Customer | Availability of Customer System Administrators, Database Administrators, IT Staff |
| Dependencies | and Project Team |
| Quality Control | Architecture Review Team |
| Participants | Initiate Project Manager |
| | Initiate Project Architect |
| | Customer Project Manager |
| | Customer System Administrator |
| | Customer Database Administrator |
| | Customer IT Staff |
| Initiate Effort | 15 Days |
| Required | |
| Customer Effort | 10 Days |
| Required | |

Project Control

| | |
|---|---|
| Definition | Project Control involves activities for managing an Initiate Systems project. |
| Key Process | PM Processes |
| Tasks | 1. Track revenue |
| | 2. Manage scope and changes |
| | 3. Manage risks and issues |
| | 4. Manage to the approved project plan |
| | 5. Manage human resources |
| | 6. Maintain QuickArrow |
| | 7. Manage project communication |
| | 8. Maintain project directory on server |
| | 9. Perform Individual Performance Reviews at the end of the Configuration |
| | Phase and Transition Phase |
| Deliverables | 1. Current revenue forecast spreadsheets |
| | 2. Change requests and change request log |
| | 3. Current risk and issues log |
| | 4. Current Microsoft Project Plan |
| | 5. Current project set-up in QuickArrow (e.g. Service Codes, et cetera) |
| | 6. Staffing plan in QuickArrow |
| | 7. Status reports, minutes and agendas |
| | 8. Current files stored on server under project directory |
| | 9. Individual performance reviews to Directors |
| Work Package | NA |
| Dependencies | |
| Customer | Customer approval of project plan and milestones |
| Dependencies | Customer participation in meetings and communication |
| Quality Control | 1. Completed bi-weekly project scorecard. (New document suggestion from |
| | Alex's team) |
| | 2. Initiate team follows work package and processes as applicable. |
| | 3. Weekly review and tracking of revenue forecast based on weekly submission |
| | of team time cards. |
| | 4. Meeting project revenue forecast; proactively communicating deviation or |
| | necessary modifications. |
| Participants | Initiate Project Manager |
| Initiate Effort | Entire duration of the project - therefore time varies. |
| Required | |
| Customer Effort | None, customer is not doing any of the Initiate management tasks. |
| Required | |

In-Project Training

| | |
|---|---|
| Definition | In-project training involves all the activities that result in training a customer to |
| | effectively use and administer the Initiate Identity Hub ™ software. This work |
| | package ensures that the customer's project teams get their training where and |
| | when they need it. |
| Key Process | Fulfilling In-project training requests |
| | Administering In-project training requests |
| Tasks | 1. Review the training section as written in the customers work |
| | order/contract/SSO |
| | 2. Conduct a meeting with IU to discuss the scope, objectives and requirements |
| | of the training and provide the customer a proposal on dates, times, topics, |
| | participants, and content of the training materials. |
| | 3. With the customer's approval, materials are created by the Initiate |
| | curriculum developer, Initiate technical trainer, project manager (optional), |
| | technical analyst (optional), partner (optional). |
| | 4. Training materials are printed and delivered at the customer's training |
| | locations and technical trainer conducts the training. |
| | 5. Training is evaluated and certificate of completion is issued to all |
| | participants. |
| Deliverable | 1. In-project training checklist - a list of items that need to be checked off to |
| | ensure a successful training. Items would include creating of training |
| | materials, location of training center, participant name, info, etc. (to be |
| | created) |
| | 2. Training Request Form - this form is constantly updated when this work |
| | package starts, until the training event is completed. |
| | 3. Training Materials |
| | 4. Presentations |
| | 5. Class Roster - Roster of participants on each course is documented by the |
| | trainer |
| | 6. Evaluation Forms - online evaluation forms are created to compile feedback |
| | of the training event and to improve Initiate University's course offerings |
| | 7. Certificates of Completion - issued to customer participants who attended the |
| | training. |
| | 8. Salesforce.com update - Customer's account on SalesForce.com is updated |
| | with the names of participants who attended the training. |
| Work Package | <<To be filled in by Initiate Project Manager during project planning phase.>> |
| Dependencies | |
| Customer | In-project training checklist |
| Dependencies | Training location |
| | 1. Participants (with contact information) for each session |
| | 2. Training environment |
| | a. Laptops (if required) |
| | b. Projectors |
| | c. Classroom set up |
| | d. Software (i.e.; MS Office, WinZip, etc.) |
| | e. Other logistics to conduct the training such as |
| Quality Control | 1. Trainer reviews materials prior to the materials being printed and shipped. |
| | 2. Initiate training coordinator, project manager, technical trainer, partner |
| | (optional) and customer project manager go through the training checklist |
| | and sign off on it. |
| | 3. Using the feedback obtained from the evaluation form, materials are updated |
| | for future training events. |
| Participants | Initiate Project Manager |
| | Initiate Technical Analysts |
| | Customer Project Manager |
| | Initiate Technical Trainer |
| | Initiate Curriculum Developer (if required) |
| | Initiate Training Coordinator |
| Initiate Effort | For a 1 hour course, effort required for development, administration and review is |
| Required | 2.5 hrs |
| Customer Effort | Hours as determined in the Implementation Course Catalog for courses outlined |
| Required | in the contract |

Configuration Hub Installation

| | |
|---|---|
| Definition | This work package defines the tasks and deliverables associated with the |
| | installation of the Initiate Identity Hub Solution. At the completion of this work |
| | package an operational identity hub engine service is delivered & knowledge |
| | transfer document completed. |
| Key Processes | Technical Analyst Project Execution Processes |
| Tasks | 1. Verify customer has proper hardware and has installed required third-party |
| | software |
| | 2. Verify Initiate has correct access to Customers server. |
| | 3. Install the Identity Hub following the Identity Hub Engine Installation guide |
| | for the version being installed. |
| | 4. Install Brokers |
| | 5. Install Clients |
| | 6. Install Configuration Tools |
| | 7. Install SDKs (if necessary) |
| | 8. Verify engine is working correctly following Quality Control checks listed |
| | below. |
| | 9. Complete knowledge transfer document. |
| Deliverable | 1. Uninterrupted MPINET service |
| | 2. Engine set up that creates log files with date/time stamp |
| | 3. Updated Implementation Approach document with any deviations/ |
| | customizations that may be part of install process |
| | 4. Updated Implementation Approach document |
| Work Package | <<To be filled in by Initiate Project Manager during project planning phase.>> |
| Dependencies | |
| Customer | Customer must have appropriate hardware and access for Initiate to get on |
| Dependencies | their system. |
| | Customer must have their Relational Database Management System on the |
| | same host as the Identity Hub software, or have client connectivity software |
| | installed. |
| Quality Control | Unit test of the Identity Hub Engine. This includes checking the log making |
| | sure the Engine has been started with no errors. Running some simple |
| | queries against database to make sure the dictionary files were loaded |
| | correctly. |
| | Use Auditor to check connection to MPINET |
| Participants | Initiate Technical Analysts |
| | Initiate Project Manager |
| | Initiate Project Architect |
| | Customer Project Manager |
| | Customer Technical Team |
| Initiate Effort | 32 hours for first engine instance |
| Required | 8 hours for every engine instance after that |
| Customer Effort | 30 minutes in setting up connection to Initiate Identity Hub Engine service by |
| Required | ensuring the port numbers are open for end users to connect to it. |

Data Extract Load and Analytics

| | |
|---|---|
| Definition | The purpose of the data analytics process is to analyze the client's data and |
| | review the results with them. The main tool used to accomplish this is an Excel |
| | spreadsheet with separate tabs for each type of test. Each tab has separate SQL |
| | statements that can be pasted into database query tool, customized to the |
| | client's data, and executed. The spread sheet is completed by Initiate and then |
| | review by the client. |
| Key Processes | Technical Analyst Project Execution Processes |
| Tasks | 1. Perform Data analysis |
| | a. Data extract validity |
| | b. Attribute validity |
| | c. Linkage information |
| | d. Review Identifiers |
| | e. Entity Size |
| | f. Bucket Analysis |
| | 2. Review and explain results with customer |
| Deliverable | 1. Completed data analytics spreadsheet |
| | 2. Customer understanding of their data analytics |
| | 3. Updated Implementation Approach document |
| Work Package | Data Preparation |
| Dependencies | Configuration Hub Installation |
| Customer | Data load must have been completed successfully. |
| Dependencies | Customer must be available to review the data. |
| Quality Control | Record volumes in analysis are confirmed with customer via file counts |
| | All record volume totals across worksheet tabs reconcile (ie. a tab reflecting |
| | 100,000 duplicates in total should carry to another date distribution duplicate |
| | total of 100,000 (80,000 1994-1998, 10,000 1999-2006, 10,000 Other) |
| | Services Data Log (Initiate Security and Privacy Policies) tracks |
| | administrative data management |
| | All spreadsheet parameters are completed or removed for each customer. |
| Participants | Initiate Project Manager |
| | Initiate Project Architect |
| | Initiate Technical Analysts |
| | Customer Project Manager |
| | Customer Project Team |
| Initiate Effort | If data loads are complete, the completion of the spreadsheet and execution of |
| Required | the SQL statements should take between 1-2 hours. |
| | Customer review meeting should take <1 hour. |
| Customer Effort | Approximately 1 hour to review/explain data analytics |
| Required | |

Configure Algorithm

| | |
|---|---|
| Definition | Configure Algorithms to provide matching, searching, and data quality |
| | remediation functionality. |
| Key Process | Technical Analyst Project Execution Processes |
| Tasks | 1. Define and document the design and configuration of the algorithm, including |
| | attributes to be compared and bucket types to be defined |
| | 2. Profile data extracts to analyze the richness of attributes considered for the |
| | algorithm |
| | 3. Configure algorithm |
| | 4. Generate weights |
| | 5. Review weights with a weights expert; request feedback from a Data |
| | Scientist if necessary |
| | 6. Load data and cross match |
| | 7. Prepare sample matches and analytics (score distribution, size of entities, |
| | bucket sizes) |
| | 8. Review sample matches and analytics internally with an algorithm expert ( |
| | 9. Incorporate feedback from internal review into the algorithm configuration; |
| | regenerate or adjust weights if necessary; rerun the cross match |
| | 10. Prepare sample matches and analytics |
| | 11. Prepare threshold analysis training materials (to be reviewed with customer |
| | resources during threshold analysis) |
| | 12. Review sample matches with the customer (threshold analysis) |
| | 13. Analyze the results of threshold analysis to determine thresholds and to |
| | identify potential algorithm improvements |
| | 14. Incorporate feedback from threshold analysis into the algorithm |
| | configuration; regenerate or adjust weights if necessary; apply thresholds; |
| | rerun the cross match |
| | 15. Prepare sample matches and analytics |
| | 16. Review sample matches with the customer (threshold analysis) |
| Deliverable | 1. Sample matches threshold analysis (multiple iterations) |
| | 2. Configured algorithm |
| | 3. Updated Implementation Approach document |
| Work Package | Data Preparation |
| Dependencies | Configuration Hub Installation |
| | Data Extract Load and Analysis |
| Customer | Deliver data extracts |
| Dependencies | Perform threshold analysis (multiple iterations) |
| Quality Control | Verify security of customer data is maintained |
| | Internal review of sample matches |
| | Internal review of analytics |
| | Review with customer results of analytics |
| | Unit tests that perform searches that utilize the algorithm |
| Participants | Initiate Project Manager |
| | Initiate Technical Analysts |
| | Initiate Data Scientist |
| | Customer Project Manager |
| | Customer Business Owners |
| Initiate Effort | 200 person hours |
| Required | |
| Customer Effort | 50 person hours |
| Required | |

Inbound Interface

| | |
|---|---|
| Definition | At the completion of this work package an operational Inbound Interface service |
| | is delivered & knowledge transfer document completed. |
| Key Processes | Technical Analyst Project Execution Processes |
| Tasks | 1. Define and document the inbound interface requirements (sometimes |
| | referred to as the Inbound Map) including the attributes to be stored and |
| | their location in inbound messages |
| | 2. Request test messages from the customer, or create test messages and ask |
| | the customer to validate them |
| | 3. Configure the inbound broker(s) in a development environment |
| | 4. Test the inbound broker(s) using the test messages |
| Deliverable | 1. Customer sent messages are queuing up in the designated interface folder |
| | for the Message Reader. |
| | 2. Message Reader is set up to create log files with date/time stamp when it is |
| | not functioning appropriately. |
| | 3. Message Reader creates input files for queued messages sent by customer's |
| | application. |
| | 4. Message Broker/Manager is set up to create log files with date/time stamp |
| | when it isn't functioning properly or when messages are not being processed |
| | appropriately. |
| | 5. Queued messages are read and processed by the Message Broker/Manager. |
| | Reject and Success files are created based on processed message. |
| | 6. Update implementation approach document with any deviations/ |
| | customizations that may be part of install process. |
| | 7. Updated Implementation Approach (incorporating unit test cases into |
| | integration test cases) |
| Work Package | Data Preparation |
| Dependencies | Configuration Hub Installation |
| | Data Extract Load and Analysis |
| Customer | Customer must have appropriate hardware and access for Initiate to get on |
| Dependencies | their system. |
| | Customer must have appropriate port open to queue messages. |
| | Customer must have Identity Hub service (mpinet) functional and accessible. |
| Quality Control | Use Auditor to check connection to MPINET service. |
| | Check Message Reader log to make sure Reader is running. |
| | Check Message Reader input queue for input files. |
| | Check Message Broker/Manager Log to make sure Broker/Manager is |
| | running. |
| | Use Auditor to check for successful messages processed by Broker/Manager. |
| | If Auditor unavailable, use SQL to query Identity Hub to verify messages has |
| | been processed successfully. |
| | For rejected messages, check Message Broker/Manager Log and Engine log |
| | to determine why message was rejected. |
| Participants | Technical Analysts |
| | Project Manager |
| | Customer Project Manager |
| | Customer Technical Team |
| Initiate Effort | 4 hours to install initial Message Reader, 1 hour for each additional instance. |
| Required | 24 hours to install, configure and test Message Broker/Manager, 4 hours for each |
| | additional instance. |
| Customer Effort | 30 minutes in setting up valid ports. 4 hours for work required for customer |
| Required | interface team to submit messages to designated port. |

HL7 Query Integration

| | |
|---|---|
| Definition | In order to give end-users, such as registrars, access to the power of Initiate |
| | searching algorithms, we need to provide a mechanism for searching the Identity |
| | Hub from legacy applications. HL7 Query Integration allows legacy applications to |
| | send search requests and receive search responses via HL7. |
| Key Process | Technical Analyst execution processes |
| Tasks | 1. Define and document the specifications for the HL7 request and response |
| | messages |
| | 2. Create or obtain example HL7 request messages for testing |
| | 3. Create Query Broker request and response configurations |
| | 4. Test Query Broker configuration using example messages |
| | 5. Install Query Broker configuration in customer test environment |
| Deliverable | 1. HL7 Query message specifications |
| | 2. Configured Query Broker |
| | 3. Updated Implementation Approach Document |
| Work Package | Data Preparation |
| Dependencies | Configuration Hub Installation |
| | Data Extract Load and Analysis |
| Customer | Legacy application must have HL7 query capability, or the customer must |
| Dependencies | contract with their application's vendor to introduce HL7 query capability |
| | Customer test environment for integration testing with legacy application |
| Quality Control | Unit test to exercise Query Broker functionality |
| Participants | Initiate Project Manager |
| | Initiate Technical Analysts |
| | Customer Project Manager |
| | Customer Business Owners |
| | Customer Process Experts |
| | Customer Business Reporting Administrator |
| Initiate Effort | 90-260 hours (possibly more), depending on the nature of testing, broken down |
| Required | as follows: |
| | 10-20 hours design and documentation |
| | 40 hours configuration |
| | 40-200 hours (possibly more) testing |
| Customer Effort | 10-20 hours design and documentation |
| Required | 40-200 hours (possibly more) testing |
| | Note that if the customer requires custom development from their application |
| | vendor, their effort will include working with their vendor and could be |
| | significantly higher. |

Outbound Integration

| | |
|---|---|
| Definition | When users change data attribute values via Initiate ™ Auditor or when the |
| | Initiate Identity Hub ™ software links records, we may need to notify downstream |
| | systems. We do this via Outbound Broker. |
| Key Process | Technical Analyst execution processes |
| Tasks | 1. Work with the customer to define and document the interface specifications, |
| | including the criteria for sending outbound messages, the format of outbound |
| | messages, and the destination and rules for routing the messages |
| | 2. Configure outbound broker |
| | 3. Unit test the outbound broker and verify the resulting messages |
| Deliverable | Configured outbound broker |
| | Updated Implementation Approach Document |
| Work Package | Data Preparation |
| Dependencies | Configuration Hub Installation |
| | Data Extract Load and Analysis |
| Customer | Agreement on outbound interface specifications |
| Dependencies | |
| Quality Control | Unit tests that create outbound messages |
| Participants | Initiate Project Manager |
| | Initiate Technical Analysts |
| | Customer Project Manager |
| | Customer Analyst (Interface Specialist) |
| Initiate Effort | 40-50 hours per interface/format |
| Required | |
| Customer Effort | 10-20 hours |
| Required | |

SDK Integration

| | |
|---|---|
| Definition | We provide various mechanisms for integrating our customer's applications with |
| | the Identity Hub. SDK Integration allows customers to write code to integrate |
| | their existing applications directly with the Initiate Identity Hub ™ software. |
| Key Process | Technical Analyst execution processes |
| Tasks | 1. Agree on high-level design/process flow of processes that will use the Initiate |
| | APIs |
| | 2. Prepare for SDK training |
| | 3. Create API Usage Guide |
| | 4. Deliver SDK training |
| | 5. Install Initiate Identity Hub ™ software in a customer development |
| | environment |
| | 6. Support customer development and testing |
| Deliverable | 1. API Usage Guide |
| | 2. SDK training |
| | 3. Updated Implementation Approach document |
| Work Package | Data Preparation |
| Dependencies | Configuration Hub Installation |
| Customer | Agreement on high-level design/process flow |
| Dependencies | Customer development environment |
| | Develop and test processes that use Initiate APIs |
| Quality Control | Customer performs testing according to their integration test plan. Services |
| | supports troubleshooting Initiate APIs test results. SKD toolkit functional testing |
| | is performed by the Initiate Research and Development team prior to product |
| | release. |
| Participants | Initiate Project Manager |
| | Initiate Technical Analysts |
| | Customer Project Manager |
| | Customer Developers |
| Initiate Effort | 50-250 hours (possibly more), depending on the nature of testing, broken down |
| Required | as follows: |
| | 5 hours high-level design |
| | 10 hours preparation for SDK training |
| | 5 hours writing API Usage Guide |
| | 4 hours (4 hours per person involved) delivering SDK training |
| | 10-200 hours (possibly more) testing |
| Customer Effort | 5 hours high-level design |
| Required | 4-20 hours (4 hours per person involved) receiving SDK training |
| | 40-1000 hours (possibly more) development and testing (depending on the |
| | complexity of their application and the interactions with the Identity Hub) |

Initiate Enterprise Integrator (EI) with (Screen Scraping) integration

| | |
|---|---|
| Definition | At the completion of this work package an operational Initiate Enterprise |
| | Integrator (with screen scraping integration) is delivered along with updated |
| | design document. |
| Key Process | Technical Analyst execution processes |
| Tasks | 1. Ensure engine service is set up and up and running |
| | 2. Verify Initiate has correct access to Customers server. |
| | 3. Gather information on emulator, request access to development copy of |
| | source system set up and conduct feasibility analysis on connecting to |
| | emulator & on screen recognition |
| | 4. Gather requirements on source system's screen flow for following scenarios |
| | (use process document & requirements template): |
| | 5. Update - Patient found in local system (the system where search initiated) |
| | 6. Add - Patient found in enterprise but does not belong to local system |
| | 7. New - Patient not found in enterprise |
| | 8. Initiate Identity Hub Engine (MPINET) is down |
| | 9. Verify customer has proper hardware requirements. (refer to implementation |
| | approach document or solution architecture document) |
| | 10. Develop screen scraping flow for scenarios captured above |
| | 11. Perform functional testing i.e. speed of typing VS response of screen |
| | scraping, or source system response time delays at peak hours |
| | 12. Provide testing guidelines to customer |
| | 13. Complete knowledge transfer document. |
| Deliverable | 1. An operational Initiate Enterprise Integration screen that recognizes source |
| | system emulator and can screen scrape to various fields on source system. |
| | 2. Packaged executables that can be installed on individual PCs. |
| | 3. Design document that shows flow of screen scraping process |
| | 4. Testing guidelines to ensure end to end testing of EI |
| | 5. Updated Implementation Approach Document |
| Work Package | Data Preparation |
| Dependencies | Configuration Hub Installation |
| Customer | Information on emulator type and quick access to development copy of |
| Dependencies | source system with user set up that looks like final end user set up. |
| | Connection to operational MPINET (for cases where customer has tight |
| | control on firewalls amongst their machines) |
| | Requirements on screen flow of end user functions |
| Quality Control | Test scenarios described in the requirements document |
| | Run tests defined in test plan |
| Participants | Initiate Technical Analysts |
| | Initiate Project Manager |
| | Customer Project Manager |
| | Customer Technical Team |
| Initiate Effort | Custom Effort to be Scoped (160 to 300 hours) |
| Required | |
| Customer Effort | Distributed participation through out the custom integration process. At least 40 |
| Required | hours |

Custom Reporting

| | |
|---|---|
| Definition | The purpose of the reporting work package is to describe the work associated |
| | with creating custom reports. This work package is dependent upon the Reporting |
| | Component being installed and initially configured. |
| Key Process | Change Management |
| | Project Management |
| | Requirements Elicitation |
| | Technical Analyst Execution Processes |
| Tasks | 1. Define and document customer's reporting needs (what data is needed) |
| | 2. Analyze customer reporting needs to determine any technical issues |
| | 3. Prototype customer's report in Dev/Test Environment |
| | 4. Revise ETL Scripts |
| | 5. Design/Prototype Report |
| | 6. Test Report |
| | 7. Review and Revise report with customer |
| | 8. Promote Report into Production Environment |
| Deliverable | 1. Custom Reporting Requirements (to be appended to Implementation |
| | Approach) |
| | 2. Custom Reports |
| | 3. ETL Script Updates |
| | 4. Updated Implementation Approach Document |
| Work Package | Data Preparation |
| Dependencies | Configuration Hub Installation |
| Customer | 1. Installed and Configured Dev/Test Environment |
| Dependencies | 2. Installed and Configured Production Environment |
| | 3. Customer approval of Reporting Requirements |
| | 4. Customer understanding of Reporting needs |
| Quality Control | Custom Report Design and Testing Processes |
| Participants | Initiate Project Manager |
| | Initiate Technical Analysts |
| | Customer Project Manager |
| | Customer Business Owners |
| | Customer Process Experts |
| | Customer Business Reporting Administrator |
| Initiate Effort | 2-3 days per custom report |
| Required | |
| Customer Effort | 2-3 days per custom report (to test and validate) |
| Required | |

Verification Hub Installation

| | |
|---|---|
| Definition | This work package defines the tasks and deliverables associated with the |
| | installation of the Initiate Identity Hub into a Test Environment. At the |
| | completion of this work package an operational identity hub engine service is |
| | delivered & knowledge transfer document completed. |
| Key Process | Project Management |
| | Communications Management |
| | Quality Management |
| | Change Management |
| | Bug/Issue Tracking Management |
| Tasks | 1. Verify customer has proper hardware requirements. (refer to |
| | implementation approach document or solution architecture document) |
| | 2. Verify Initiate has correct access to Customers server. |
| | 3. Install the Identity Hub following the Identity Hub Engine Installation guide |
| | for the version being installed. |
| | 4. Verify engine is working correctly following Quality Control checks listed |
| | below. |
| | 5. Complete knowledge transfer document. |
| Deliverable | 1. Uninterrupted MPINET service |
| | 2. Engine set up that creates log files with date/time stamp |
| | 3. Update implementation approach document with any deviations/ |
| | customizations that may be part of install process |
| Work Package | Solution Architecture |
| Dependencies | Data Load and Analytics |
| | Configure Algorithm |
| | Inbound Broker Configuration |
| | HL7 Query Integration |
| | Outbound Broker Configuration |
| | Enterprise Integrator Configuration |
| | SDK Integration |
| | Custom Reporting |
| Customer | Customer must have appropriate hardware and access for Initiate to get |
| Dependencies | on their system. |
| | Customer must have their Relational Database Management System on the |
| | same host as the Identity Hub software, or have client connectivity |
| | software installed. |
| Quality Control | Unit test of the Identity Hub Engine. This includes checking the log making |
| | sure the Engine has been started with no errors. Running some simple |
| | queries against database to make sure the dictionary files were loaded |
| | correctly |
| | Use Auditor to check connection to MPINET |
| Participants | Initiate Technical Analysts |
| | Initiate Project Manager |
| | Customer Project Manager |
| | Customer Technical Team |
| Initiate Effort | 32 hours for first engine instance |
| Required | 8 hours for every engine instance after that |
| Customer Effort | 30 minutes in setting up connection to Initiate Identity Hub Engine service by |
| Required | ensuring the port numbers are open for end users to connect to it. |

Functional Testing

| | |
|---|---|
| Definition | Functional Testing bases its test cases on the specifications of the software |
| | component under test. For example, any customer-driven changes to the |
| | software configurations or custom changes to the software that would not be in |
| | product development. Functional testing typically involves five steps: |
| | 1. The identification of functions that the software is expected to perform |
| | 2. The creation of input data based on the function's specifications |
| | 3. The determination of output based on the function's specifications |
| | 4. The execution of the test case |
| | 5. The comparison of actual and expected outputs |
| Key Process | Project Management |
| | Communications Management |
| | Quality Management |
| | Change Management |
| | Bug/Issue Tracking Management |
| Tasks | 1. Document Functional Plan and Tests based on Implementation Approach |
| | and Functional Requirements |
| | 2. Perform Functional Test against Test Environment |
| | 3. Document results and necessary functional changes |
| Deliverable | Implementation Approach - Functional Requirements |
| | Functional Test Plan and Test Cases |
| | Solution Change Requests |
| | Updated Implementation Approach |
| Work Package | Access to the Customer Verification Hub Installation |
| Dependencies | Installed Initiate software required for the test |
| | Solution Architecture |
| | Configure Algorithm |
| | Inbound Broker Configuration |
| | HL7 Query Integration |
| | Outbound Broker Configuration |
| | Enterprise Integrator Configuration |
| | SDK Integration |
| | Custom Reporting |
| | <<Additional dependencies to be filled in by Initiate Project Manager during |
| | project planning phase.>> |
| Customer | 1. Defined Business Requirements |
| Dependencies | 2. Testing Environment installed and configured according to Solution |
| | Architecture and Implementation Approach |
| | 3. Approved Implementation Approach for component being functionally |
| | tested |
| | 4. Approved Functional Test Plan and Test Cases |
| Quality Control | Functional Testing Quality Guidelines |
| Participants | Initiate Project Manager |
| | Initiate Technical Analysts |
| | Initiate QA Lead |
| | Customer Project Manager |
| | Customer Business Process Analyst |
| | Customer QA Lead |
| Initiate Effort | 2-4 hours per functional test case |
| Required | |
| Customer Effort | 2-4 hours per functional test case |
| Required | |

Integration Testing

| | |
|---|---|
| Definition | System integration testing is the integration testing of two or more system |
| | components. Specifically, system integration testing is the testing of software |
| | components that have been distributed across the CDI ecosystem. |
| | The objective is to test and produce failures caused by system integration |
| | defects (i.e., defects involving exchange of data or procedure calls across |
| | boundaries of various systems). |
| | A system integration test suite is comprised of test cases for each interface |
| | between distributed software components, (e.g: Setting up the algorithm and |
| | testing broker behavior.) |
| Key Process | Project Planning & Management |
| | Communications Management |
| | Quality Management |
| | Change Management |
| | Bug/Issue Tracking Management. |
| Tasks | 1. In the project planning phase get commitment for customer involvement. |
| | 2. Document system interactions and integration points in implementation |
| | approach document with appropriate solution architecture diagrams and |
| | process flow diagrams. |
| | 3. Complete integration test plan and test cases template (i.e., broker |
| | configuration use cases). |
| | 4. Execute test cases at least 2-3 weeks prior to go live. |
| | 5. Document integration test results (template). |
| Deliverable | 1. Integration test plan and test cases. |
| | 2. Integration testing results |
| | 3. Log bugs/issues encountered. |
| | 4. Remediation to correct any issues encountered. |
| | 5. Sign off from the customer to go live or next steps. |
| | 6. Change request form. (If applicable). |
| Work Package | Access to the Customer Verification Hub Installation |
| Dependencies | Installed Initiate software required for the test |
| | Solution Architecture |
| | Data Load and Analytics |
| | Configure Algorithm |
| | Inbound Broker Configuration |
| | HL7 Query Integration |
| | Outbound Broker Configuration |
| | Enterprise Integrator Configuration |
| | SDK Integration |
| | Custom Reporting |
| | Functional Verification |
| | <<Additional dependencies to be filled in by Initiate Project Manager during |
| | project planning phase.>> |
| Customer | Approved Implementation Approach - Integration Points. |
| Dependencies | Approved test environment. |
| Quality Control | Quality Management Guidelines associated with Integration Testing |
| Participants | Initiate Project Manager |
| | Initiate Technical Analysts |
| | Customer Project Manager |
| | Customer IT Architect |
| | Customer Process Experts |
| Initiate Effort | 10-15 Days |
| Required | |
| Customer Effort | 10-15 Days |
| Required | |

User Acceptance Testing

| | |
|---|---|
| Definition | Acceptance test is jointly performed by end users or sponsors with Initiate Project |
| | Team through black-box testing (i.e., the testers need not know anything about |
| | the internal workings of the system). The results will determine acceptance of the |
| | system. |
| | Acceptance tests generally take the form of a suite of tests designed to be run on |
| | the completed system. Each individual test, known as a case, exercises a |
| | particular operating condition of the user's environment or feature of the system, |
| | and will result in a pass or fail Boolean outcome. There is generally no degree of |
| | success or failure. The test environment is usually designed to be identical, or as |
| | close as possible, to the anticipated user's production environment, including |
| | extremes of such. These case tests must each be accompanied by test case input |
| | data or a formal description of the operational activities (or both) to be |
| | performed-intended to thoroughly exercise the specific case-and a formal |
| | description of the expected results. |
| Key Process | Communications Management |
| | Project Management |
| | Quality Management |
| | Bug/Issue Tracking Management |
| Tasks | 1. Review Implementation Approach for Customer Business Requirements |
| | 2. Construct and Review User Acceptance Criteria with Customer |
| | 3. Gain customer approval of UAT Criteria as documented |
| | 4. Perform collaborative UAT according to UAT Test Plan (UAT Template) |
| | 5. Document results of UAT (Does Customer Accept) |
| | 6. If customer accepts, proceed to Production Go Live |
| Deliverable | UAT Document and Test Cases |
| | UAT Plan - Acceptance Document |
| | Customer Acceptance of the Solution Configuration |
| Work Package | Solution Architecture |
| Dependencies | Verification Hub Installation |
| | Functional Verification |
| | Integration Verification |
| | <<To be filled in by Initiate Project Manager during project planning phase.>> |
| Customer | 1. Approved Business Requirements |
| Dependencies | 2. Approved UAT Criteria |
| | 3. Installed and Configured Verification and Production Environments |
| Quality Control | Quality Management Processes for UAT |
| Participants | Initiate Project Manager |
| | Initiate Technical Analysts |
| | Customer Project Manager |
| | Customer Project Sponsor |
| | Customer Process Expert |
| | Customer QA Lead |
| | Customer Stakeholders |
| Initiate Effort | 5 Days |
| Required | |
| Customer Effort | 30 Days |
| Required | |

Performance Testing

| | |
|---|---|
| Definition | The performance testing work package is designed to prove out the performance |
| | of the Initiate Identity Hub solution architecture and the business services built |
| | around the hub in customer specific environments. |
| | The goal of performance testing is to measure the performance of the system and |
| | ensure performance meets customer requirements To conduct performance |
| | testing is to engage in a carefully controlled process of measurement and |
| | analysis. |
| Key Process | Project Planning & Management |
| | Communications Management. |
| | Quality Management. |
| Tasks | 1. In the project planning phase get commitment for customer involvement. |
| | 2. Define customer performance testing expectations and goals. |
| | 3. Review and agree to performance test plan and test cases |
| | 4. Load sample data into production environment for performance testing |
| | 5. Perform iterative performance test, review results and benchmark |
| | 6. Fine tune environment (database, application servers, network, web servers, |
| | bucketing and customer code for API calls (threading, memory management |
| | . . . etc). |
| | 7. Document system, application and environmental changes and retest |
| | 8. Document results in a performance analysis document (template). |
| Deliverable | 1. Performance testing definition and test cases template. |
| | 2. Performance analysis/statistics document |
| | 3. Updated implementation approach document. |
| Work Package | Solution Architecture |
| Dependencies | Verification Hub Installation |
| | <<To be filled in by Initiate Project Manager during project planning phase.>> |
| Customer | 1. Installed and configured scaled production environment (similar hardware |
| Dependencies | and software in a scaled environment). |
| | 2. Sample population of production level data for performance testing. |
| | 3. Agree to performance testing parameters. |
| Quality Control | Performance Testing Guidelines |
| Participants | Initiate Project Manager |
| | Initiate Technical Analysts |
| | Initiate Project Architect |
| | Customer Project Manager |
| | Customer System Administrator |
| | Customer IT Manager |
| | Customer QA Lead |
| | Customer Process Experts |
| Initiate Effort | 10 days |
| Required | |
| Customer Effort | 10 days |
| Required | |

Production Identity Hub Installation

| | |
|---|---|
| Definition | This work package defines the tasks and deliverables associated with the |
| | installation of the Initiate Identity Hub into Production. At the completion of this |
| | work package an operational identity hub engine service is delivered & knowledge |
| | transfer document completed. |
| Key Process | Project Planning & Management |
| | Communications Management. |
| | Quality Management. |
| Tasks | 1. Verify customer has proper hardware requirements. (refer to implementation |
| | approach document or solution architecture document) |
| | 2. Verify Initiate has correct access to Customers server. |
| | 3. Install the Identity Hub following the Identity Hub Engine Installation guide |
| | for the version being installed. |
| | 4. Verify engine is working correctly following Quality Control checks listed |
| | below. |
| | 5. Complete knowledge transfer document. |
| Deliverable | 1. Uninterrupted MPINET service |
| | 2. Engine set up that creates log files with date/time stamp |
| | 3. Update implementation approach document with any deviations/ |
| | customizations that may be part of install process |
| Work Package | Solution Architecture |
| Dependencies | User Acceptance Testing |
| | <<Additional dependencies to be filled in by Initiate Project Manager during |
| | project planning phase.>> |
| Customer | Customer must have appropriate hardware and access for Initiate to get on |
| Dependencies | their system. |
| | Customer must have their Relational Database Management System on the |
| | same host as the Identity Hub software, or have client connectivity software |
| | installed. |
| Quality Control | Unit test of the Identity Hub Engine. This includes checking the log making |
| | sure the Engine has been started with no errors. Running some simple |
| | queries against database to make sure the dictionary files were loaded |
| | correctly |
| | Use Auditor to check connection to MPINET |
| Participants | Initiate Technical Analysts |
| | Initiate Project Manager |
| | Initiate Project Architect |
| | Customer Project Manager |
| | Customer Technical Team |
| Initiate Effort | 32 hours for first engine instance |
| Required | 8 hours for every engine instance after that |
| Customer Effort | 30 minutes in setting up connection to Initiate Identity Hub Engine service by |
| Required | ensuring the port numbers are open for end users to connect to it. |

Production Go-Live Support

| | |
|---|---|
| Definition | The Production Go-Live Support work package contains a set of tasks gears to |
| | promoting the Identity Hub solution into production, monitoring performance and |
| | addressing any issues |
| Key Process | Project Planning & Management |
| | Communications Management. |
| | Quality Management. |
| Tasks | 1. Review Go-No Go Decision with Customer |
| | 2. Load Production Data Extracts into Production Identity Hub |
| | 3. Turn on Message Brokers |
| | 4. Turn on API Adapters |
| | 5. Process ETL scripts |
| | 6. Review daily Reports from Reporting Database |
| Deliverable | Daily Production Reports |
| | Daily Transaction Logs |
| Work Package | Production Hub Installation |
| Dependencies | Production Verification |
| | Solution Architecture |
| | <<To be filled in by Initiate Project Manager during project planning phase.>> |
| Customer | System Administrator available for mentoring |
| Dependencies | End user responsible for executing Go-Live check list be available |
| Quality Control | 1. Execute go live checklist: |
| | 2. Client to validate data loaded in Initiate Identity Hub database |
| | 3. Run basic unit testing analytics and compare the stats with results from dry |
| | run |
| Participants | Initiate Project Manager |
| | Initiate Technical Analysts |
| | Initiate Solution Architect |
| | Customer Project Manager |
| | Customer System Administrator |
| | Customer IT Manager |
| | Customer QA Lead |
| | Customer Process Experts |
| Initiate Effort | 10 days |
| Required | |
| Customer Effort | 10 days |
| Required | |

Production Verification

| | |
|---|---|
| Definition | This work package defines the tasks and deliverables associated with verifying |
| | that the production installation of the hub meets the customer's requirements. |
| Key Process | Project Planning & Management |
| | Communications Management. |
| | Quality Management. |
| Tasks | 1. Test client connectivity with Auditor and Enterprise Viewer |
| | 2. Test configuration tool connectivity with Hub Manager, Hierarchy Manager, |
| | Algorithm Manager, Workbench, etc.) |
| | 3. Test connectivity with Message Broker Transaction |
| | 4. Test connectivity with API call |
| | 5. Process ETL script to populate Reporting database |
| Deliverable | Production Ready Identity Hub Installation |
| Work Package | Production Hub Installation |
| Dependencies | Solution Architecture |
| | User Acceptance Testing |
| | <<To be filled in by Initiate Project Manager during project planning phase.>> |
| Customer | Access to production Identity Hub Installation |
| Dependencies | |
| Quality Control | 1. Unit test of the Identity Hub Engine. This includes checking the log making |
| | sure the Engine has been started with no errors. Run queries against |
| | database to make sure the dictionary files were loaded correctly |
| | 2. Use Auditor to check connection to MPINET |
| | 3. Review messaging logs, engine logs for any error/warning messages |
| | 4. Run quick check on selective reports to ensure success of ETL process |
| | 5. Test custom components and approve |
| Participants | Initiate Technical Analysts |
| | Initiate Project Manager |
| | Customer Project Manager |
| | Customer Technical Team |
| Initiate Effort | 32 hours for first engine instance |
| Required | |
| Customer Effort | 30 minutes to verify Initiate access to the environment. |
| Required | |

Transfer of Knowledge (TOK)

| | |
|---|---|
| Definition | At the completion of a project, Project Manager will develop and present a |
| | presentation to the customer outlining the results of the project. The purpose of |
| | this TOK is to provide the customer with the information necessary to support the |
| | solution post implementation. |
| | For DQR projects, it's a presentation on findings, data analysis, data trends and |
| | recommended next steps. |
| Key Process | Project Planning & Management |
| | Communications Management. |
| | Quality Management. |
| Tasks | 1. Schedule Transfer of Knowledge (TOK) session with customer at least 3-4 |
| | weeks. |
| | 2. Run the statistics SQL query to obtain the final project statistics |
| | presentation. |
| | 3. Review draft presentation with customer Project Manager |
| | 4. Present the TOK on the scheduled date and time. |
| | 5. Place a copy of the TOK presentation in the Document Repository section in |
| | the appropriate Customer Folder |
| Deliverable | TOK presentation |
| Work Package | Production Go Live Support |
| Dependencies | <<To be filled in by Initiate Project Manager during project planning phase.>> |
| Customer | Customer scheduling the Transfer of Knowledge session with Initiate |
| Dependencies | Systems staff. |
| Quality Control | 1. Review final statistics and final mathematical calculations included in the TOK |
| | presentation |
| | 2. Quality check slides for typos, fonts, colors, alignment etc. |
| | 3. Distribute a draft of the presentation to other Initiate project team members, |
| | Project Director and/or other Services Group team members as appropriate |
| | for feedback and input. |
| | 4. Distribute a draft of the presentation to the customer Project Manager for |
| | review and comment prior to final presentation. |
| Participants | Initiate Project Manager |
| | Initiate Technical Analysts |
| | Customer Project Manager |
| | Customer Project Team as designated (HIM, IT, Lab, Radiology) |
| Initiate Effort | 8 Hours over the course of the entire DQR project |
| Required | |
| Customer Effort | 1-3 Hours - Includes review of draft presentation, scheduling time and actual |
| Required | presentation time. |

Transition to Customer Support Group

| | |
|---|---|
| Definition | The purpose of this work package is to describe the tasks and deliverables |
| | associated with transitioning a customer implementation to CSG |
| Key Process | Services to CSG Transition Process |
| Tasks | 1. Make a formal request to CSG to Transition customer implementation |
| | 2. Schedule Internal Audit and Internal Services to CSG Call |
| | 3. Update customer profile in SFDC |
| | 4. Schedule Customer Transition to CSG Call |
| | 5. Attend and manage Customer Transition to CSG Call |
| | 6. Complete Transition Call |
| Deliverable | Transition to CSG Plan |
| | Guide to CSG Support |
| Work Package | Production Go-Live Support |
| Dependencies | <<To be filled in by Initiate Project Manager during project planning phase.>> |
| Customer | Attend Transition to CSG Call |
| Dependencies | Two trained and approved ATSC |
| Quality Control | CSG verifies customer environment and it passes criteria |
| Participants | Initiate Project Manager |
| | Initiate CSG Contact |
| | Customer Project Manager |
| | Customer System Administrator |
| | Customer Process Experts |
| Initiate Effort | 3 Days |
| Required | |
| Customer Effort | 3 Days |
| Required | |

Project Close Down

| | |
|---|---|
| Definition | At the completion of this work package a project will be considered closed and |
| | completed. |
| Key Process | Project Planning & Management |
| | Communications Management. |
| | Quality Management. |
| Tasks | 1. Archive all data from customer per Archiving Data Process Document. |
| | 2. Archive all project related artifacts per Archiving Project Artifacts Process |
| | Document. |
| | 3. Prepare and set up Post Mortem meeting per Post Mortem Process |
| | Document. |
| | 4. Prepare and Set up Transition to CSG meeting per Transition to CSG Process |
| | Document. |
| | 5. Prepare and Set Up Project Review meeting per Project Review Project |
| | Document. |
| Deliverable | A fully documented and completed Project. |
| | Resources Invited to Post Mortem |
| Work Package | Transition of Knowledge |
| Dependencies | Transition to Customer Support Group |
| | <<To be filled in by Initiate Project Manager during project planning phase.>> |
| Customer | Customer not considering project complete |
| Dependencies | |
| Quality Control | Lessons' Learned are posted to the Services Wiki Page |
| Participants | Initiate Project Manager |
| | Customer Project Manager |
| | Customer Technical Team |
| Initiate Effort | 40 hours to document various components for each of the steps. |
| Required | |
| Customer Effort | 30 minutes to attend Transition to CSG meeting. |
| Required | |

What is claimed is:

1. A method of project management, comprising:
defining a work package of a project, wherein defining the work package comprises:
analyzing project materials of a project to determine stand alone work; and
grouping one or more tasks operable to implement the stand alone work to form a stand alone set of tasks, wherein the work package comprises the set of tasks, wherein the set of tasks defines the work package and wherein the performance of the set of tasks during the execution of the work package produces a deliverable;
developing the work package, wherein developing the work package comprises:
associating an input or predecessor with the work package;
allocating a resource to the work package;
integrating a process associated with the work package into the work package;
determining dependencies; and
including the determined dependencies in the work package; and
arranging the work package in a sequence of execution within the project relative to other work packages of the project, wherein the execution of work packages in the sequence of execution produces a project result.

2. The method of claim 1, wherein the deliverable is a tangible result.

3. The method of claim 1, wherein the project result is in accordance with a goal of the project.

4. The method of claim 3, wherein the project result is a product.

5. The method of claim 1, further comprising defining the process.

6. The method of claim 1, wherein the execution of the work package completes the stand alone work.

7. The method of claim 1, wherein arranging the work package is based on the determined dependencies.

8. A method of project management, comprising:
defining work packages of a project, wherein defining work packages comprises:
analyzing project materials of a project to determine a plurality of stand alone work; and
grouping tasks implementing the plurality of stand alone work to form stand alone sets of tasks, each set of tasks corresponding to stand alone work and defining a work package, wherein each work package comprises the set of tasks defining the work package and wherein the execution of each work package comprises the performance of the set of tasks defining the work package and produces a deliverable; and
arranging the work packages in a sequence of execution within the project, wherein arranging the work packages in a sequence of execution comprises:
analyzing the work packages;
determining dependencies between the work packages, wherein determining dependencies between the work packages comprises determining the work packages which utilize deliverables and the work packages which produce the utilized deliverables; and
arranging the work packages in a sequence of execution, wherein the sequence of execution is based on dependencies between work packages of the work packages and wherein the execution of the work packages in the sequence of execution produces a project result in accordance with a goal of the project.

9. The method of claim 8, wherein a deliverable produced by a work package is a tangible result.

10. The method of claim 8, further comprising allocating a resource to each work package.

11. The method of claim 8, further comprising defining a process for each work package.

12. The method of claim 8, wherein work packages are arranged in a sequence of execution wherein a first work package producing a deliverable utilized by a second work package is executed prior to the execution of the second work package.

13. The method of claim 8, wherein the execution of a work package completes stand alone work.

14. The method of claim 8, wherein a deliverable produced by a work package is independently utilizable.

15. A method of project management, comprising:
defining work packages of a project, wherein defining work packages comprises:
analyzing project materials of a project to determine a plurality of stand alone work; and
grouping tasks implementing the plurality of stand alone work to form stand alone sets of tasks, each set of tasks corresponding to stand alone work and defining a work package, wherein each work package comprises the set of tasks defining the work package and wherein the execution of each work package comprises the performance of the set of tasks defining the work package and produces a deliverable;
developing the work packages, wherein developing a work package of the work packages comprises:
associating an input or predecessor with the work package;
allocating a resource to the work package;
integrating a process associated with the work package into the work package;
determining dependencies to other work packages; and
including the determined dependencies in the work package; and
arranging the work packages in a sequence of execution within the project, wherein arranging the work packages comprises:
analyzing the work packages;
determining dependencies between the work packages, wherein determining dependencies between the work packages comprises the determining work packages which utilize deliverables and the work packages which produce the utilized deliverables; and
arranging the work packages in a sequence of execution, wherein the sequence of execution is based on dependencies between work packages of the work packages and wherein the execution of the work packages in the sequence of execution produces a project result in accordance with a goal of the project.

16. The method of claim 15, wherein a deliverable produced by a work package is a tangible result.

17. The method of claim 15, further comprising defining a process for each work package.

18. The method of claim 15, wherein work packages are arranged in a sequence of execution wherein a first work package producing a deliverable utilized by a second work package is executed prior to the execution of the second work package.

19. The method of claim 15, wherein the execution of a work package completes stand alone work.

20. The method of claim 15, wherein a deliverable produced by a work package is independently utilizable.
